(19) United States
(12) Patent Application Publication
(10) Pub. No.: US 2005/0142302 A1
(43) Pub. Date: Jun. 30, 2005

(54) Alignment-layer-attached film for optical element use

(76) Inventor: Runa Nakamura, Tokyo-to (JP)

Correspondence Address: LADAS & PARRY LLP, 224 SOUTH MICHIGAN AVENUE, SUITE 1200, CHICAGO, IL, 60604, US

(21) Appl. No.: 10/903,426

(22) Filed: Jul. 30, 2004

(30) Foreign Application Priority Data
Jul. 31, 2003 (JP) 2003-204429

(51) Int. Cl. C09K 19/00

(52) U.S. Cl. 428/1.2

(57) ABSTRACT

It is a main object of the present invention to provide an alignment-layer-attached film for optical element use in which liquid crystals can be aligned in a direction crossing a longitudinal direction of a transparent base material and which is excellent in productivity, by using a method of transferring a concavo-convex shape, which is formed to align the liquid crystals, onto the transparent base material, as well as the optical element using the alignment-layer-attached film for optical element use. The above-mentioned object of the present invention can be achieved by providing an alignment-layer-attached film for optical element use, comprising: a long transparent base material; and an alignment layer formed on the transparent base material, wherein the alignment layer comprising a resin having a concavo-convex shape to align liquid crystals.

### BACKGROUND OF THE INVENTION

1. Field of the Invention

The present invention relates to an alignment-layer-attached film for optical element use in which liquid crystals can be aligned in a direction crossing a longitudinal direction of a long transparent base material, as well as an optical element.

2. Description of the Related Art

Currently, many optical compensating elements are used for Liquid Crystal Displays (hereinafter referred to as LCD). Liquid crystals have refraction anisotropy in which the refractive index varies depending on directions, so that when the LCD is observed from an oblique angle, the display quality deteriorates as it becomes darker. In order to improve the dependency on an angle of visibility, optical compensating elements capable of performing optical compensation are required (Japanese Patent Application Laid-open (JP-A) No. 10-154380, and JP-A No. 11-258605). As the optical compensating elements, those prepared by drawing polymer to a single axis or prepared by aligning liquid crystal molecules are listed. Because of larger anisotropy owned, the optical compensating element using liquid crystal molecules can characteristically perform the same function in a 1/10 thickness, as compare to the optical compensating element using polymer.

If the dependency on the angle of visibility is improved by using the optical compensating element for the LCD, typically, the optical compensating element is pasted with a polarizing plate such that their optical axes (an absorbing axis in the polarizing plate and an optical axis in the optical compensating element) make a particular angle, and incorporated into the LCD. For example, in JP-A No. 11-258605, the optical axis of the optical compensating element and the absorbing axis of the polarizing plate are crossed at right angles.

In the meantime, as a base material used in preparing the optical compensating element by using liquid crystals, a thinner base material is required; namely, a film base material is used more often. It is also required to align liquid crystals at a certain angle with respect to the longitudinal direction of the film base material. The reason is as follows. As described above, if the dependency on the angle of visibility is improved by using the optical compensating element for the LCD, it is required that the optical axis of the optical compensating element is at a particular angle, such as 45° and 90°, with respect to the absorbing axis of the polarizing plate. The polarizing plate is typically prepared by drawing a polymer film in the longitudinal direction, so that the absorbing axis thereof faces in the longitudinal direction of the film base material. In order to paste the optical compensating element and the polarization plate whose absorbing axis faces in the longitudinal direction of the film base material as described above, cut them into a predetermined size, and incorporate them into the LCD, it is necessary to prepare the optical compensating element such that the optical axis thereof is at an arbitrary angle, such as 45° and 90°, with respect to the longitudinal direction of the film base material.

If the optical compensating element using liquid crystals is prepared, an alignment layer to align liquid crystals on the base material is required. In general, there are the following methods: a method of aligning liquid crystals in a rubbing direction by coating polymer, such as polyimide, onto the base material and by performing a rubbing operation referred to as rubbing (“Liquid Crystal Display technology”, the 2^{nd} edition, Sangyo Tosyo, Co., Ltd., 1997.11.14, pp265-274; a method of aligning liquid crystals in a polarization direction by irradiating the alignment layer with polarized ultraviolet (UV) rays (“Basic, Application, Practice, and Technical Trend of liquid crystal Alignment Operation” seminar materials, Tokyo Technology Information Service, 2001.9.21, pp59-69, and “Frontiers of Liquid Crystal Display” second impression of the 1^{st} edition, Sigma Syuppan, Co., Ltd, 1998.7.5, pp108-119); and further, a method of aligning liquid crystals in a deposition direction by obliquely depositing Silicon oxide (SiO) and Titanium dioxide (TiO₂) or the like onto the base material (“Frontiers of Liquid Crystal Display” second impression of the 1 st edition, Sigma Syuppan, Co., Ltd., 1998.7.5, pp108-119, and “liquid crystal and Application” seventh impression of the ₁st edition, Sangyo Tosyo, Co., Ltd., 1989.6.12, pp7l-74).

If it is desired to use the rubbing method as the alignment method, it is difficult that a long film base material having an alignment direction crossing the longitudinal direction of the film base material is prepared by continuously rubbing with a brush or the like at an angle with respect to the longitudinal direction of the film base material. On the other hand, if the method of irradiation of the polarized UV or the method of obliquely depositing SiO or the like is used as the alignment method, it is possible to satisfy such a requirement that the liquid crystal are aligned at an angle other than the longitudinal direction of the film base material; however, the both methods are expensive, so that if the film base material is treated for a long time in a continuous roll-to-roll process, it is difficult to precisely maintain the angle and distance between the base material and a deposition source or the UV polarization. In particular, the oblique deposition has a problem of poor productivity.

Moreover, JP-A No. 8-313910 discloses a method of directly transferring the alignment of liquid crystal molecules without the rubbing process on the base material. This method, however, has a treatment process using a sheet, in which a planar mold made of resin is used as a transferring member, and has difficulty in producing a long alignment-layer-attached film for optical element use or the like stably and continuously.

### SUMMARY OF THE INVENTION

The present invention is achieved in view of the above mentioned problems, and a main object of the present invention is to provide an alignment-layer-attached film for optical element use in which liquid crystals can be aligned in a direction crossing a longitudinal direction of a transparent base material and which is excellent in productivity, by using a method of transferring a concavo-convex shape, which is formed to align the liquid crystals, onto the transparent base material, as well as the optical element using the alignment-layer-attached film for optical element use.

In order to achieve the above-mentioned object, the present invention provides an alignment-layer-attached film for optical element use, comprising: a long transparent base material; and an alignment layer formed on the transparent base material, wherein the alignment layer comprising a resin having a concavo-convex shape to align liquid crystals.

By adjusting the concavo-convex shape to align the liquid crystals, it is possible to provide the alignment-layer-attached film for optical element use in which the liquid crystals can be aligned in the direction crossing the longitudinal direction of the transparent base material.

In the present invention, it is preferable that an alignment direction of the liquid crystals aligned by the concavo-convex shape crosses a longitudinal direction of the transparent base material. This is because, for example, if the above-described alignment-layer-attached film for optical element use is used for preparation of the optical compensating element in order to improve the dependency on an angle of visibility of the LCD, the optical compensating element can be pasted with the polarizing plate whose absorbing axis faces in the longitudinal direction of the long transparent base material, cut into a predetermined size, and incorporated into the LCD. It is also because it is possible to provide the optical compensating element having such desired optical properties, easily and inexpensively.

Moreover, in the present invention, it is preferable that the alignment layer comprises a cured curing resin. This is because the curing resin improves the stability of the concavo-convex shape to align the liquid crystals.

The above object of the present invention can be also achieved by an optical element, comprising: a long transparent base material; an alignment layer formed on the transparent base material; and a liquid crystal layer aligned and fixed by the alignment layer, wherein the alignment layer comprising a resin having a concavo-convex shape to align liquid crystals.

By adjusting the concavo-convex shape to align the liquid crystals, it is possible to provide the optical element in which the liquid crystals are aligned in the direction crossing the longitudinal direction of the transparent base material.

In the present invention, it is preferable that an alignment direction of the liquid crystals aligned by the concavo-convex shape crosses a longitudinal direction of the transparent base material. This is because, for example, if the above-described optical element is used as the optical compensating element in order to improve the dependency on an angle of visibility of the LCD, the optical compensating element can be pasted with the polarizing plate whose absorbing axis faces in the longitudinal direction of the long transparent base material, cut into a predetermined size, and incorporated into the LCD. It is also because it is possible to provide the optical compensating element having such desired optical properties, easily and inexpensively.

Moreover, in the present invention, it is preferable that the alignment layer comprises a cured curing resin. This is because the curing resin improves the stability of the concavo-convex shape to align the liquid crystals.

The present invention also provides a method for manufacturing an alignment-layer-attached film for optical element use, which comprises: a long transparent base material which can be continuously displaced; and an alignment layer formed on the transparent base material, the method for manufacturing comprising: a coating process of coating a curing resin composition onto a transferring member having a concavo-convex shape to align liquid crystals; a curing process of curing the curing resin composition to be a curing resin; a placing process of placing the transparent base material onto a surface of the curing resin composition or the curing resin; and a transferring process of delaminating the transferring member from the curing resin composition or the curing resin and transferring the concavo-convex shape of the transferring member to the curing resin.

In the present invention, by forming the concavo-convex shape of the transferring member such that liquid crystals are aligned in the direction crossing the longitudinal direction of the long transparent base material, it is possible to provide the alignment-layer-attached film for optical element use in which the liquid crystals can be aligned in the direction crossing the longitudinal direction of the transparent base material by using the transferred concavo-convex shape. Moreover, there is also such an advantage that the productivity improves since it is possible to mass-produce the alignment-layer-attached film for optical element use in which the liquid crystals can be aligned in the direction crossing the longitudinal direction of the transparent base material, by producing once an original plate of the transferring member.

In the present invention, it is preferable that the concavo-convex shape to align the liquid crystals is formed by oblique deposition. The reason is as follows. In the oblique deposition method, the shape of the concavo-convex structure formed on the base material is changed by changing an angle between the direction of a deposition source (deposition direction) and a direction perpendicular to the surface of the base material, so that the alignment direction of the liquid crystals can be changed. Thus, the concavo-convex structure is formed in a direction perpendicular to the deposition direction along the surface of the transferring member, by setting the angle between the deposition direction and the direction perpendicular to the surface of the transferring member, to a particular angle. By transferring the concavo-convex shape to the transparent base material, it is possible to align the liquid crystals in the direction crossing the longitudinal direction of the transparent base material in accordance with the transferred concavo-convex shape.

Moreover, in the present invention, it is preferable that the concavo-convex shape to align the liquid crystals is formed by rubbing. This is because by performing the rubbing with respect to the surface of the transferring member to align the liquid crystals in the direction crossing the longitudinal direction of the transparent base material, it is possible to transfer the concavo-convex shape to the transparent base material, and it is possible to align the liquid crystals in the direction crossing the longitudinal direction of the transparent base material in accordance with the transferred concavo-convex shape.

Moreover, in the present invention, it is preferable that the transferring member is displaced by a cylindrical drum for transfer and the long transparent base material is displaced by a cylindrical drum for the base material, and the coating process, the placing process in which the curing resin composition or the curing resin is contacted with the transparent base material on the two cylindrical drums, and the transferring process are continuously performed. This is because the transfer of the shape can be continuously performed on the transparent base material through the roll-to-roll process, so that the productivity improves.

The present invention also provides a method for manufacturing an alignment-layer-attached film for optical element use, which comprises: a long transparent base material which can be continuously displaced; and an alignment layer formed on the transparent base material, the method for manufacturing comprising: a coating process of coating a curing resin composition onto the transparent base material; a curing process of curing the curing resin composition to be a curing resin; a placing process of placing a transferring member having a concavo-convex shape to align liquid crystals, onto a surface of the curing resin composition or the curing resin; and a transferring process of delaminating the transferring member from the curing resin composition or the curing resin on the transparent base material and transferring the concavo-convex shape of the transferring member to the curing resin.

By forming the concavo-convex shape of the transferring member such that liquid crystals are aligned in the direction crossing the longitudinal direction of the long transparent base material, it is possible to provide the alignment-layer-attached film for optical element use in which the liquid crystals can be aligned in the direction crossing the longitudinal direction of the transparent base material by using the transferred concavo-convex shape. Moreover, there is also such an advantage that the productivity improves since it is possible to mass-produce the alignment-layer-attached film for optical element use in which the liquid crystals can be aligned in the direction crossing the longitudinal direction of the transparent base material, by producing once an original plate of the transferring member.

In the present invention, it is preferable that the concavo-convex shape to align the liquid crystals is formed by oblique deposition. The reason is as follows. As described above, in the oblique deposition method, the concavo-convex structure is formed in the direction perpendicular to the deposition direction along the surface of the transferring member, by setting the angle between the deposition direction and the direction perpendicular to the surface of the transferring member, to a particular angle. By transferring the concavo-convex shape to the transparent base material, it is possible to align the liquid crystals in parallel, in the direction crossing the longitudinal direction of the transparent base material in accordance with the transferred concavo-convex shape.

Moreover, in the present invention, it is preferable that the concavo-convex shape to align the liquid crystals is formed by rubbing. As described above, this is because by performing the rubbing with respect to the surface of the transferring member to align the liquid crystals in the direction crossing the longitudinal direction of the transparent base material, it is possible to transfer the concavo-convex shape to the transparent base material, and it is possible to align the liquid crystals in parallel, in the direction crossing the longitudinal direction of the transparent base material in accordance with the transferred concavo-convex shape.

Moreover, in the present invention, it is preferable that the transferring member is displaced by a cylindrical drum for transfer and the long transparent base material is displaced by a cylindrical drum for the base material, and the coating process, the placing process in which the curing resin composition or the curing resin is contacted with the transferring member on the two cylindrical drums, and the transferring process are continuously performed. This is because the transfer of the shape can be continuously performed on the transparent base material through the roll-to-roll process, so that the productivity improves.

The present invention also provides a method for manufacturing an optical element, comprising: an alignment-layer-attached film for optical element use forming process of forming an alignment-layer-attached film for optical element use by the method for manufacturing an alignment-layer-attached film for optical element use according to claim 7; and a liquid-crystal-layer-forming process of coating liquid crystals onto an alignment layer of the alignment-layer-attached film for optical element use, performing an alignment treatment, and fixing alignment of the liquid crystals.

In the method for manufacturing an optical element, in which the method for manufacturing an alignment-layer-attached film for optical element use which has the above-described benefit is used, it is possible to provide an optical element in which liquid crystals can be aligned in the direction crossing the longitudinal direction of the transparent base material.

### BRIEF DESCRIPTION OF THE DRAWINGS

FIG. 1 is a schematic cross sectional view showing one example of an alignment-layer-attached film for optical element use of the present invention;

FIG. 2A to FIG. 2E are process diagrams showing one example of a method for manufacturing the alignment-layer-attached film for optical element use of the present invention;

FIG. 3A and FIG. 3B are schematic cross sectional views to explain an oblique deposition method;

FIG. 4A to FIG. 4E are process diagrams showing another example of the method for manufacturing the alignment-layer-attached film for optical element use of the present invention;

FIG. 5A to FIG. 5E are process diagrams showing another example of the method for manufacturing the alignment-layer-attached film for optical element use of the present invention;

FIG. 6 is a process diagram showing another example of the method for manufacturing the alignment-layer-attached film for optical element use of the present invention;

FIG. 7A to FIG. 7E are process diagrams showing another example of the method for manufacturing the alignment-layer-attached film for optical element use of the present invention;

FIG. 8A to FIG. 8E are process diagrams showing another example of the method for manufacturing the alignment-layer-attached film for optical element use of the present invention;

FIG. 9A to FIG. 9E are process diagrams showing another example of the method for manufacturing the alignment-layer-attached film for optical element use of the present invention;

FIG. 10 is a process diagram showing another example of the method for manufacturing the alignment-layer-attached film for optical element use of the present invention; and

FIG. 11 is a schematic cross sectional view showing one example of an optical element of the present invention.

### DESCRIPTION OF THE PREFERRED EMBODIMENT

The present invention will be specifically explained below. The present invention includes: an alignment-layer-attached film for optical element use; an optical element using the alignment-layer-attached film; and method for manufacturing the same. Each will be explained below in a different section.

A. Alignment-Layer-Attached Film for Optical Element Use

The alignment-layer-attached film for optical element use of the present invention comprises: a long transparent base material; and an alignment layer formed on the transparent base material, the alignment layer comprising a resin having a concavo-convex shape to align liquid crystals.

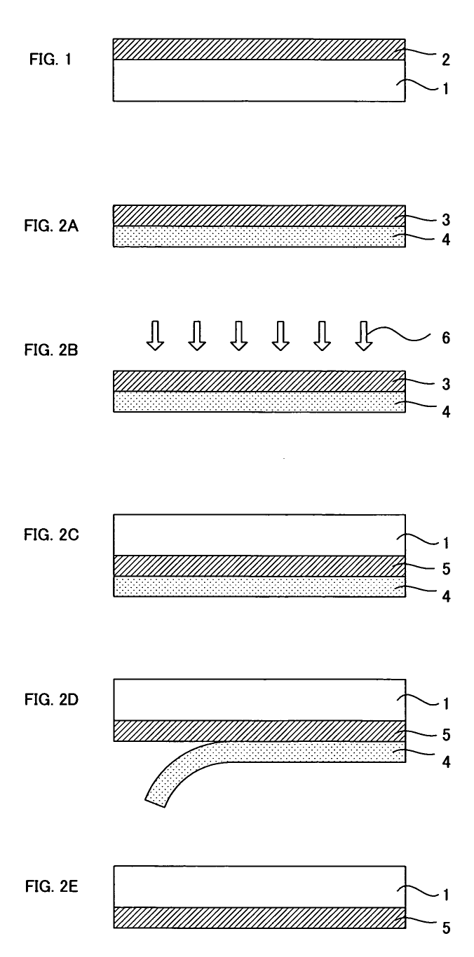

The alignment-layer-attached film for optical element use of the present invention will be explained with reference to the drawings. As shown in FIG. 1, the alignment-layer-attached film for optical element use has: a long transparent base material 1; and an alignment layer 2 formed on the transparent base material 1.

In the present invention, by adjusting the concavo-convex shape to align the liquid crystals, it is possible to provide the alignment-layer-attached film for optical element use in which the liquid crystals can be aligned in the direction crossing the longitudinal direction of the transparent base material.

For example, if the optical compensating element using liquid crystals is incorporated in order to improve the angle of visibility of the LCD, it is necessary to paste the polarizing plate and the optical compensating element such that the absorbing axis of the polarizing plate and the optical axis of the optical compensating element make a particular angle, such as 90°. The polarizing plate is typically prepared by drawing or orienting a polymer film in the longitudinal direction, so that the absorbing axis thereof faces in the longitudinal direction of the film base material. In the optical compensating element prepared by using the conventional rubbing method, liquid crystals are aligned in the longitudinal direction of the base material, so that it is necessary to cut it into a predetermined size and paste it with the polarizing plate. However, in the optical compensating element in which the alignment-layer-attached film for optical element use of the present invention is used, liquid crystals can be aligned in the direction crossing the longitudinal direction of the transparent base material, so that there is such an advantage that it can be pasted, as it is, with the polarizing plate whose absorbing axis faces in the longitudinal direction of the base material.

Incidentally, in the present invention, “to align liquid crystals in the direction crossing the longitudinal direction of the long transparent base material” means that a director of the aligned liquid crystals has an angle (not 0°) with respect to the longitudinal direction of the transparent base material.

Each construction of the alignment-layer-attached film for optical element use will be explained below.

1. Long Transparent Base Material

The long transparent base material used in the present invention is not particularly limited if used for the optical element. For example, it is possible to use: transparent rigid materials without flexibility, such as quarts or silica glass, Pyrex (registered trademark) glass, and a synthetic quarts plate; or transparent flexible materials with flexibility, such as a transparent resin film and a resin plate for optics. Among them, it is preferable to use the transparent flexible materials with flexibility with a light transmittance of 80% or more, and particularly those having optical isotropy. As the materials, cellulose-based resin, norbornene-based resin, cycloolefin-based resin and the like, and further, polycarbonate, polyarylate, polysulfone, polyethersulfone and the like can be used in a form of film. Even among them, a TAC (Tri-Acetyl Cellulose) film is preferable. As commercial products made of the above materials, ZENEOX (manufactured by Japan Zeon Co., Ltd.), ARTON (manufactured by JSR Co., Ltd.), FUJITAC (manufactured by FUJI PHOTO FILM, CO., LTD.) and the like are listed.

In the present invention, as described later, a transferring member having a concavo-convex shape to align liquid crystals is displaced or moved by a cylindrical drum for transfer, and the long transparent base material is displaced or moved by a cylindrical drum for the base material, and it is preferable to form the alignment layer by coating a curing resin composition onto the transferring member, by contacting the curing resin composition or the curing resin with the transparent base material on the two cylindrical drums, by delaminating or peel off the transferring member from the curing resin composition or the curing resin on the transparent base material, and by continuously transferring the concavo-convex shape of the transferring member to the curing resin. This is because if the transparent base material is the transparent flexible material with flexibility with a light transmittance of 80% or more, the transfer of the shape can be continuously performed on the transparent base material through the roll-to-roll process, so that the productivity improves.

Moreover, in order to improve close adhesion between the transparent base material and the alignment layer, a surface treatment may be performed onto the transparent base material. Specifically, a glow discharge treatment, a corona discharge treatment, a UV treatment, a saponification treatment, and the like can be used. Moreover, a primer layer may be formed on the transparent base material. Furthermore, the primer layer (barrier layer) may be provided for the purpose of protection of the transparent base material from the curing resin. As the primer layer, for example, silane-based and titanium-based coupling agents and the like are listed.

2. Alignment Layer

Next, the alignment layer used in the present invention will be explained. The alignment layer used in the present invention comprises a resin having a concavo-convex shape to align liquid crystals.

In the present invention, the concavo-convex shape to align liquid crystals is preferably formed by transfer. This is because by forming the concavo-convex shape of the transferring member such that liquid crystals are aligned in the direction crossing the longitudinal direction of the long transparent base material, it is possible to provide the alignment-layer-attached film for optical element use in which the liquid crystals can be aligned in the direction crossing the longitudinal direction of the transparent base material by using the transferred concavo-convex shape. Moreover, it is also because the productivity improves since it is possible to mass-produce the alignment-layer-attached film for optical element use in which the liquid crystals can be aligned in the direction crossing the longitudinal direction of the transparent base material, by producing once an original plate of the transferring member.

Each construction of the alignment layer will be explained below.

a. Transferring Member

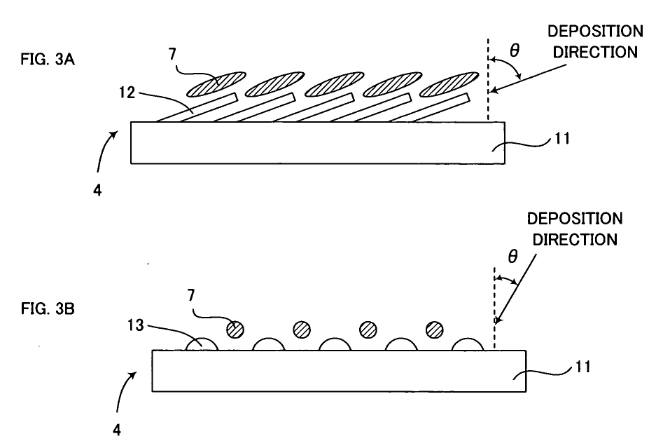

First, the transferring member used in the present invention will be explained. The transferring member used in the present invention has a concavo-convex shape to align liquid crystals. In the present invention, for example, as shown in FIG. 3A and FIG. 3B, the transferring member has: a base member 11 for a transferring member; and a concavo-convex shape 12 or 13 formed on the base member 11 for a transferring member.

The base member for a transferring member is not particularly limited if capable of forming the concavo-convex shape to align liquid crystals, however it is selected, as occasion demands, depending on a method of irradiation of energy in curing the curing resin composition as described later. Namely, transparent materials are required if energy is applied from the transferring member side; however, the materials are not particularly limited to be transparent if energy is applied from the transparent base material side.

Moreover, the base member for a transferring member may have flexibility, such as a resin film, or may not have flexibility, such as glass. In the present invention, the transferring member is used repeatedly, so that materials with predetermined strength are preferably used. Specifically, glass, ceramic, metal, plastic, and the like are listed. Such materials are selected, as occasion demands, depending on a method of forming the concavo-convex shape to align liquid crystals, as described later.

Moreover, the transferring member is preferably displaced by the cylindrical drum for transfer, in transferring the concavo-convex shape of the transferring member to the curing resin, as described later. Furthermore, the transferring member is preferably the cylindrical drum for transfer; namely, the concavo-convex shape to align liquid crystals is preferably formed on the surface of the cylindrical drum for transfer. This is because the transfer of the shape can be continuously performed on the transparent base material through the roll-to-roll process, so that the productivity improves.

In the present invention, as the method of forming the concavo-convex shape to align liquid crystals, it is preferable to form the concavo-convex shape by which liquid crystals are aligned in the direction crossing the longitudinal direction of the transparent base material. Specifically, the oblique deposition method, the rubbing method, and the like are listed. The oblique deposition method and the rubbing method will be explained below.

(Oblique Deposition Method)

The oblique deposition method is to form the alignment layer by setting molecules or atoms evaporated from a deposition source to enter or inject from an oblique angle with respect to a base member and by forming a deposition film onto the base member. In the present invention, as shown in FIG. 3A and FIG. 3B, a transferring member 4 is formed by setting molecules or atoms evaporated from a deposition source to enter or inject from an oblique angle with respect to the base member 11 for a transferring member and by forming the deposition film 12 or 13 onto the base material 11 for a transferring member. As shown in FIG. 3A, if the deposition is performed such that the base member 11 for a transferring member is greatly inclined with respect to the deposition direction, to thereby make an angle θ of 80 to 85° between the direction of the deposition source (deposition direction) and a direction perpendicular to the surface of the base member 11 for a transferring member, then, micro-crystals which become a thin film, such as SiO, have a prism-like structure projecting in an oblique direction with respect to the direction of the deposition source, and liquid crystal molecules 7 are aligned along the lateral surfaces of the prism-like structures 12. On the other hand, as shown in FIG. 3B, if an angle θ, at which the base member 11 for a transferring member is inclined, is set to 45 to 6520 , a thin film of fine banded concavo-convex structures 13 is formed in a direction perpendicular to the deposition direction, along the surface of the base member 11 for a transferring member, and liquid crystal molecules 7 are aligned along the grooves of the banded concavo-convex structures 13 (wherein the major axis of the liquid crystal molecule 7 faces in a direction perpendicular to the sheet in FIG. 3B). As described above, a difference in the direction of the deposition source with respect to the surface of the base member 11 for a transferring member allows oblique alignment (FIG. 3A) and parallel alignment (FIG. 3B). Incidentally, the oblique deposition method is described in detail in “Frontiers of Liquid Crystal Display” (second impression of the 1 st edition, pp108-119, Sigma Syuppan, Inc., 1998) , “Latest Technology of liquid crystal” (the 3^{rd} edition, pp55-56, Kogyo Chosakai Publishing Inc., 1984), and “World of liquid crystal” (fourth impression of the 1^{st} edition, pp74-77, Sangyo Tosho, Co., Ltd., 1997).

In the present invention, the alignment direction of the aligned liquid crystals is preferably the direction crossing the longitudinal direction of the transparent base material, preferably crossing at 90°±2° or 45°±2°, and particularly preferably crossing at 90°±0.5° or 45°±0.50° with respect to the longitudinal direction of the transparent base material. Therefore, in the present invention, it is preferable to set, as shown in FIG. 3B, the angle θ between the direction perpendicular to the base member for a transferring member and the deposition direction in a range of 45 to 65°. The reason is as follows. In the present invention, the alignment-layer-attached film for optical element use is formed by transferring the concavo-convex shape of the transferring member to the curing resin on the transparent base material, so that it is possible to align liquid crystals in the direction crossing the longitudinal direction of the long transparent base material by forming, in the above set range, the concavo-convex shape which is transferred.

Moreover, as the deposition source, Silicon Monoxide (SiO), Silicon Dioxide (SiO₂), Titanium Dioxide (TiO₂) and the like are listed. Among them, SiO₂ is preferably used.

In the present invention, as described above, it is preferable that the concavo-convex shape to align the liquid crystals on the transferring member is formed by the oblique deposition method. This is because in the oblique deposition method, as described above, the concavo-convex shape to align liquid crystals can be easily formed in the direction crossing the longitudinal direction of the transparent base material, by setting the angle between the deposition direction and the direction perpendicular to the surface of the base member for a transferring member, to a predetermined angle.

(Rubbing Method)

The rubbing method is typically to form the alignment layer in which liquid crystals are aligned in a rubbing direction, by coating polymer, such as polyimide, onto the base material and by rubbing the base material with a roller wrapped with a cloth or the like. In the present invention, the concavo-convex shape to align liquid crystals is formed on the base member for a transferring member, so that the rubbing is performed with respect to the base member for a transferring member. It is preferable that the transferring member has the concavo-convex shape in which liquid crystals can be aligned in the direction crossing the longitudinal direction of the long transparent base material, and that the transferring member is used repeatedly. Thus, in the present invention, the concavo-convex shape to align liquid crystals is formed on the base member for a transferring member, in the following manner by using the rubbing method, for example.

Namely, it is such that the rubbing is performed with respect to the metallic base member for a transferring member, by using a rubbing roll wrapped with a cloth or the like, to thereby form rubbing traces on the surface of the base member for a transferring member, wherein the rubbing traces are the concavo-convex shape to align liquid crystals and are regarded as the transferring member.

In order to form the concavo-convex shape in which liquid crystals can be aligned in the direction crossing the longitudinal direction of the long transparent base material, for example, in the case where the transferring member is shaped like the cylindrical drum, the rubbing may be performed by contacting the rubbing roll with the cylindrical drum to cross at right angles.

b. Resin

Next, the resin used in the present invention will be explained.

In the present invention, the alignment layer comprises a resin having a concavo-convex shape to align liquid crystals. Moreover, as described above, the concavo-convex shape to align the liquid crystals is preferably formed by transfer to the resin on the transparent base material. In order to stabilize the transferred concavo-convex shape, the resin is preferably a curing resin, prepared by curing a curing resin composition.

As the curing resin composition used in the present invention, an energy-ray curing resin composition which is cured by the irradiation of energy rays, or a thermosetting resin composition which is cured by heat is listed. Among them, in the present invention, the energy-ray curing resin composition is preferable. As the energy-ray curing resin composition, a UV curing resin composition which is cured by irradiation of UV rays, an electron-ray curing resin composition which is cured by irradiation of electron rays, and the like are listed, however, the UV curing resin composition is preferable among them. This is because a method of using UV rays as the energy rays is an already established technique, so that its application to the present invention is easy.

The UV curing resin composition is not particularly limited if cured by the irradiation of UV rays, however, it is preferably a multifunctional monomer component and/or an oligomer component and/or a polymer component that are photo polymerized and cured.

The multifunctional monomer component is not particularly limited, however, a multifunctional acrylate monomer is preferably used. Specifically, ethylene glycol (meth)acrylate, dietylene glycol di(meth)acrylate, propylene glycol di(meth)acrylate, dipropylene glycol di(meth)acrylate, polyethylene glycol di(meth)acrylate, polypropylene glycol di(meth)acrylate, hexane di(meth)acrylate, neopentyl glycol di(meth)acrylate, glycerin di(meth)acrylate, glycerin tri(meth)acrylate, tri-methylolpropane tri(meth)acrylate, 1,4-butanediol diacrylate, pentaerythritol (meth)acrylate, pentaerythritol tri(meta)acrylate, pentaerythritol tetra(meta)acrylate, dipentaerythritol hexa(meth)acrylate, dipentaerythritol penta(meth)acrylate and the like are listed.

The oligomer component is not particularly limited, however, for example, urethane acrylate, epoxy acrylate, polyester acrylate, epoxy, vinylether, polyene thiol-based oligomers and the like are listed.

The polymer component is not particularly limited, however, for example, photocrosslinking polymer is listed, and specifically, polyvinyl cinnamate resin which allows photodimerization and the like can be used.

Moreover, as a photopolymerization initiator which is added to the UV curing resin composition, a photo-radical initiator which can be activated by UV rays, at a wavelength of 365 nm or less, for example, is used. Specifically, the following can be exempliefied: benzophenone, methyl o-benzoylbenzoate, 4,4-bis(dimethylamino)benzophenone, 4,4-bis(diethylamino)benzophenone, α-aminoacetophenone, 4,4-dichlorobenzophenone, 4-benzoyl-4-methyldiphenylketone, dibenzylketone, fuluorenone, 2,2-diethoxyacetophenone, 2,2-dimethoxy-2-phenylacetophenone, 2-hydroxy-2-methylpropiophenone, p-tert-butyldichroloacetophenone, thioxanthone, 2-methylthioxanthone, 2-chlorothioxanthone, 2-isopropylthioxanthone, diethylthioxanthone, benzyldimethylketal, benzylmethoxyehtylacetal, benzoinmethylether, benzoinbutylether, anthraquinone, 2-tert-butylanthraquinone, 2-amylanthraquinone, β-chloroanthraquinone, anthrone, benzanthrone, dibenzsuberone, methyleneanthrone, 4-azidobenzylacetophenone, 2,6-bis(p-azidobenzylidene)cyclohexanone, 2,6-bis(p-azidobenzylidene)-4-methylcyclohexanone, 2-phenyl-1,2-butadione-2-(o-methoxycarbonyl)oxim, 1-phenyl-propanedione-2-(o-ethoxycarbonyl)oxim, 1,3-diphenyl-propanetrione-2-(o-ethoxycarbonyl)oxim, 1-phenyl-3-etoxy-propanetrione-2-(o-benzoyl)oxim, Michler's ketone, 2-methyl-1[4-(methylthio)phenyl]-2-morpholinopropane-1-one, 2-benzyl-2-dimethylamino-1-(4-morpholinophenyl)-buta none, naphtharene sulfonyl chloride, quinoline sulfonyl chloride, n-phenylthioacridone, 4,4-azobisisobutyronitrile, diphenyldisulfide, benzthiazoldisulfide, triphenylphosphine, camphorquinone, N1717 manufactured by ADEKA.Co.,Ltd., carbon tetrabromide, tribromophenylsulfone, benzoyl peroxide, a combination of a photoreduction type dye, such as Eosin and methyleneblue, and a reducing agent, such as ascorbic acid and triethanolamine, and the like. In the present invention, one or more types of photopolymerization initiators can be combined and used.

The content of the photopolymerization initiator in the UV curing resin composition is preferably in a range of 0.5 to 30 weight %, and particularly preferably in a range of 1 to 10 weight%.

Moreover, solvents which can be used for the UV curing resin composition, the following can be exemplified: methanol, ethanol, n-propanol, isopropanol, ethylene glycol, propylene glycol, and the like in alcohols; α- or β-terpineol and the like in terpenes; acetone, methylethylketone, cyclohexanone, N-methyl-2-pyrrolidone and the like in ketones; toluene, xylene, tetramethylbenzene and the like in aromatic carbohydrates; cellosolve, methyl cellosolve, ethyl cellosolve, carbitol, methyl carbitol, ethyl carbitol, butyl carbitol, propylene glycol monomethylether, propylene glycol monoethylether, dipropylene glycol monomethylether, dipropylene glycol monoethylether, triethylene glycol monomethylether, triethylene glycol monoethylether and the like in glycolethers; ethyl acetate, butyl acetate, cellosolve acetate, ethyl cellosolve acetate, butyl cellosolve acetate, carbitol acetate, ethyl carbitol acetate, butyl carbitol acetate, propylene glycol monomethylether acetate, propylene glycol monoethylether acetate and the like in acetic acid esters. Moreover, one or more types of the solvents can be mixed and used.

In the present invention, in some cases, the UV curing resin composition is coated without addition of the solvents thereto. The content of the solvents in the UV curing resin composition is preferably in a range of 0 to 99.9 weight %, and particularly preferably in a range of 0 to 80 weight %.

The reason to set the contents of the photopolymerization initiator and the solvent in the above-described ranges is as follows. In the present invention, the curing resin composition is placed and cured on the transferring member, to thereby prepare the curing resin to which the concavo-convex shape of the transferring member is transferred, and to thereby form the alignment layer. Thus, the curing resin composition is placed on the transferring member with such a predetermined viscosity that it can get into and fill spaces of the concavo-convex shape, e.g., a concavo-convex structure, of the transferring member. Therefore, the UV curing resin composition can have the predetermined viscosity if the contents are in the above-described ranges, which is preferable.

Incidentally, the method for forming the alignment layer used in the present invention will be described in “C. Method for manufacturing Alignment-Layer-Attached Film for Optical Element Use” as described later, so that its explanation is omitted here.

B. Optical Element

Next, the optical element of the present invention will be explained. The optical element of the present invention comprises: a long transparent base material; an alignment layer formed on the transparent base material; a liquid crystal layer aligned and fixed by the alignment layer, wherein the alignment layer comprising a resin having a concavo-convex shape to align liquid crystals.

The optical element of the present invention will be explained with reference to a drawing. As shown in FIG. 11, the optical element of the present invention has: the long transparent base material 1; the alignment layer 2 formed on the transparent base material 1; and a liquid crystal layer 8 formed on the alignment layer 2.

If the optical element of the present invention is used as the optical compensating element, it is possible to align liquid crystals in the direction crossing the longitudinal direction of the transparent base material, by forming the concavo-convex shape to align the liquid crystals such that the liquid crystals are aligned in the direction crossing the longitudinal direction of the long transparent base material.

For example, if the optical compensating element using liquid crystals is incorporated in order to improve the angle of visibility of the LCD, it is necessary to paste the polarizing plate and the optical compensating element such that the absorbing axis of the polarizing plate and the optical axis of the optical compensating element make a particular angle, such as 90°. The polarizing plate is typically prepared by drawing a polymer film in the longitudinal direction, so that the absorbing axis thereof faces in the longitudinal direction of the film base material. In the optical compensating element prepared by using the conventional rubbing method, liquid crystals are aligned in the longitudinal direction of the base material, so that it is necessary to cut it into a predetermined size and paste it with the polarizing plate. In the optical compensating element of the present invention, liquid crystals can be aligned in the direction crossing the longitudinal direction of the transparent base material, so that it can be pasted, as it is, with the polarizing plate whose absorbing axis faces in the longitudinal direction of the base material. Moreover, it is possible to provide the optical compensating element having such desired optical properties, easily and inexpensively.

The optical element of the present invention has the alignment-layer-attached film for optical element use. The long transparent base material, the alignment layer, the transferring member, and the like are the same as those described in “A. Alignment-Layer-Attached Film for Optical Element Use”, so that their explanations are omitted here. The other structures of the optical element as described above will be explained below.

1. Liquid Crystal Layer

First, the liquid crystal layer used in the present invention will be explained. In the liquid crystal layer used in the present invention, liquid crystals are aligned by using the concavo-convex shape. Moreover, it is preferable, in the liquid crystal layer, that the liquid crystals are aligned in the direction crossing the longitudinal direction of the long transparent base material. This is because, for example, if the optical element of the present invention is used as the compensating element in order to improve the dependency on an angle of visibility of the LCD, the optical compensating element can be pasted with the polarizing plate whose absorbing axis faces in the longitudinal direction of the long transparent base material, cut into a predetermined size, and incorporated into the LCD. It is also because it is possible to provide the optical compensating element having such desired optical properties, easily and inexpensively.

In the present invention, as materials for forming the liquid crystal layer, liquid crystal materials are used. The liquid crystal materials in the present invention indicate materials which can form the liquid crystal phase at a predetermined temperature. The liquid crystal materials are cured with predetermined liquid crystal regularity, to thereby form the liquid crystal layer. Each construction of the liquid crystal layer of this type will be explained below.

a. Liquid Crystal Materials

The liquid crystal materials in the present invention indicate materials which can form the liquid crystal phase at a predetermined temperature. The liquid crystal materials are cured with predetermined liquid crystal regularity, to thereby form the liquid crystal layer. Therefore, the upper limit of the predetermined temperature is not particularly limited if not damaging the transparent base material and the alignment layer. Specifically, from the viewpoints of ease of control of a process temperature and maintenance of size precision, it is preferable to use the liquid crystal materials which can form the liquid crystal phase at 100° C. or less, and preferably at 80° C. or less. On the other hand, the lower limit of the temperature at which the liquid crystal materials can form the liquid crystal phase may be a temperature at which the liquid crystal materials can maintain their alignment condition in a temperature condition if used as the optical element.

Now, there are two conceivable conditions, as the conditions of the liquid crystal materials if the optical element of the present invention is used as the optical compensating element. Namely, in the present invention, as described later, non-polymerizable polymer liquid crystal materials may be used, and polymerizable liquid crystal materials may be used. As this type of liquid crystal materials, typically, materials with Nematic regularity or Smectic regularity are used.

In the case of the polymerizable liquid crystal materials, they are polymerized by irradiation of predetermined active radiation and used in preparation of the optical element, as explained in “2. Method for forming Liquid Crystal Layer” described later. Therefore, if used as the optical element, the liquid crystal materials have already been polymerized, and the alignment condition is fixed. Thus, with respect to the polymerizable liquid crystal materials, the lower limit of the temperature at which the liquid crystal phase is formed is not particularly limited.

On the other hand, if the non-polymerizable polymer liquid crystal materials are used as the optical element, the liquid crystal phase is a glass condition. If the temperature increases during storage or use and the materials become in an isotropic condition, the alignment direction is disordered and the materials cannot be used as the optical element any more. Therefore, if the non-polymerizable polymer liquid crystal materials are used in the present invention, the temperature at which an isotropic phase is formed may be preferably higher than or equal to the predetermined temperature. In this case, the lower limit of the temperature at which the isotropic phase is formed varies according to the application, however, it may be generally 80° C. or more, preferably 100° C. or more.

As the polymerizable liquid crystal materials, it is possible to use any of polymerizable liquid crystalline monomers, polymerizable liquid crystalline oligomers, and polymerizable liquid crystalline polymer. On the other hand, as the non-polymerizable liquid crystal materials, as described above, it is required that the alignment condition is unchanged at the use or storage temperature of the optical element, so that it is preferable to use the liquid crystal materials which make the isotropic phase at a relatively high temperature.

In the present invention, it is preferable to use the polymerizable liquid crystal materials. This is because such polymerizable liquid crystal materials can be polymerized by the irradiation of active radiation or the like, as described later, to thereby fix the alignment condition, so that the alignment of liquid crystals can be easily performed in a low temperature condition. It is also because the alignment condition is fixed in use, so that the materials can be used regardless of a use condition, such as temperature.

In the present invention, particularly, it is preferable to use the polimerizable liquid crystalline monomers. This is because the polymerizable liquid crystalline monomers can align at lower temperatures and their sensitivity in the alignment is higher, as compared to the other polymerizable liquid crystal materials, i.e., polymerizable liquid crystalline oligomers and polymerizable liquid crystalline polymers, so that they can be aligned easily.

As one example of such polymerizable liquid crystal materials, for example, the following polymerizable liquid crystalline monomers can be listed.

Namely, those composed of compounds (I) represented by the following general formula (1) and compounds (II) represented by the following general formula (2) are listed.

As the compounds (I), two types of compounds included in the general formula (1) can be mixed and used. In the same manner, as the compounds (II), two or more types of compounds included in the general formula (2) can be mixed and used.

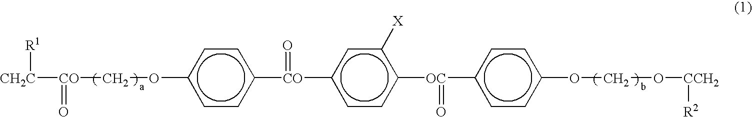

In the general formula (1), which represents the compounds (I), R¹ and R² each represents hydrogen or a methyl group, however, both R¹ and R² are preferably hydrogen, from the viewpoint of the temperature range in which the liquid crystal phase appears. X may be hydrogen, chlorine, bromine, iodine, an alkyl group having the number of carbon atoms of 1 to 4, methoxyl group, cyano group, nitro group. However, X is preferably chlorine or a methyl group. Moreover, a and b, each representing the chain length of an alkylene group, which is a spacer between a (meth)acryloyloxy group on the end of the molecular chain of the compounds (I) and an aromatic ring, can be individually any integer of 2 to 12, preferably 4 to 10, and more preferably 6 to 9. A compound in the general formula (1) in which a=b=O has poor stability and can be easily hydrolyzed, on top of which the crystalline degree of the compound itself is high. Moreover, compounds in the general formula (1) in which a and b are individually 13 or more have low isotropic transition temperatures (TI). For this reason, the both compounds have the narrow temperature range in which the liquid crystal properties appear, so that they are not preferable to use.

The compounds (I) can be synthesized in an arbitrary method. For example, the compounds (I) with X being a methyl group can be prepared by an esterification reaction of 1 equivalent of methylhydroquinone with 2 equivalents of 4-(m-(meth)acryloyloxyalkoxy)benzoate. In the esterification reaction, typically, the above-described benzoate is activated by acid chloride and sulfonic acid anhydride or similar agents, and reacted with methylhydroquinone. Moreover, it is also possible to directly react the carbonic acid unit with methylhydroquinone by using a condensing agent, such as DCC (Dicyclohexylcarbodiimide). Except this method, the compounds (I) can be synthesized even by a method in which, firstly, 1 equivalent of methylhydroquinone is esterified with 2 equivalents of 4-(m-benzyloxyalkoxy)benzoate , secondly, the prepared ester is debenzylated by a hydrogenation reaction or similar reactions, and lastly, the acryloyl groups are introduced to the molecular ends. In the estrification reaction of methylhydroquinone with 4-(m-benzyloxyalkoxy)benzoate, it is also possible to directly prepare the ester by introducing methyhydroquinone to diacetate before reacting it with the above-described benzoate in a melting condition. The compounds (I) with X of the general formula (1) not being a methyl group can be prepared by the same reaction as the above, by using hydroquinone having the corresponding substituent, instead of methylhydroquinone.

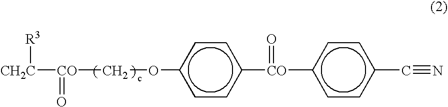

In the general formula (2), which represents the compounds (II), R³ represents hydrogen or a methyl group, however, R³ is preferably hydrogen from the viewpoint of the temperature range in which the liquid crystal phase appears. With respect to c, which represents the chain length of an alkylene group, the compounds (II) with the value of c of 2 to 12 do not show liquid crystal properties. However, in view of compatibility with the compounds (I) having liquid crystal properties, c is preferably in a range of 4 to 10, and more preferably 6 to 9. The compounds (II) can be also synthesized by an arbitrary method. For example, the compounds (II) can be synthesized by an esterification reaction of 1 equivalent of 4-cyanophenol with 1 equivalent of 4-(n-(meth)acryloyloxyalkoxy)benzoate. In the esterification reaction, as in the synthesis of the compounds (I), typically, the above-described benzoate is activated by acid chloride and sulfonic acid anhydride or similar agents, and reacted with 4-cyanophenol. Moreover, it is also possible to react the above-described benzoate with 4-cyanophenol by using a condensing agent, such as DCC (Dicyclohexylcarbodiimide).

In the present invention, it is also possible to use polymerizable liquid crystalline oligomers and polymerizable liquid crystalline polymers and the like. As such polymerizable liquid crystalline oligomers and polymers, it is possible to select and use conventionally-suggested oligomers and polymers, as occasion demands.

Moreover, in the present invention, the photopolymerization initiator can be used if necessary. This is because the photopolymerization initiator is typically used to accelerate the polymerization in the case of the curing by the irradiation of UV rays, which are generally used, although the photopolymerization initiator is unnecessary in some cases, for example, when the polymerizable liquid crystal materials are polymerized by the irradiation of electron rays.

As the photopolymerization initiator used in the present invention, the following can be listed: benzil (also referred to as bibenzoyl) , benzoin isobutyl ether, benzoin isopropyl ether, benzophenone, benzoylbenzoate, methyl benzoylbenzoate, 4-benzoyl-4′-methyldiphenylsulfide, benzylmethylketal, dimethylaminomethylbenzoate, 2-n-butoxyethyl-4-dimethylaminobenzoate, isoamyl p-dimethylaminobenzoate, 3,3′-dimethyl-4-methoxybenzophenone, methylbenzoylfomate, 2-methyl-1-(4-(metylthio)phenyl)-2-morpholinopropane-1-one, 2-benzyl-2-dimethylamino-l-(4-morpholinophenyl)-buta n-1-one, 1-(4-dodecylphenyl)-2-hydroxy-2-methylpropane-1-one, 1-hydroxycyclohexylphenylketone, 2-hydroxy-2-methyl-1-phenylpropane-1-one, 1-(4-isopropylphenyl)-2-hydroxy-2-methylpropane-1-one, 2-chlorothioxanthone, 2,4-diethylthioxanthone, 2,4-diisopropylthioxanthone, 2,4-dimethylthioxanthone, isopropylthioxanthone, 1-chloro-4-propoxythioxanthone, and the like. Incidentally, it is also possible to add a sensitizing agent in addition to the photopolymerization initiator, to an extent not hindering the purpose of the present invention.

The photopolymerization initiator can be added to the polymerizable liquid crystal materials in the present invention, typically, in a dosage range of 0.01 to 20 weight %, preferably 0.1 to 10 weight %, and more preferably 0.5 to 5 weight %.

On the other hand, in the present invention, as described above, it is possible to use the non-polymerizable liquid crystal materials. The liquid crystal materials are not particularly limited if the alignment condition of liquid crystals does not change during storage or use of the optical element, as described above. Typically, however, those formed with polymer materials are preferably used, in relation to the temperature at which a liquid phase or the liquid crystal phase is formed. In regard to such liquid crystal materials, general materials can be used if capable of forming a Nematic phase or a Smectic phase in the liquid crystal phase condition. The liquid crystal materials may be liquid crystal polymers of a main-chain type or those of a side-chain type.

Specifically, as the liquid crystal polymers of the main-chain type, for example, polyester-based, polyamide-based, polycarbonate-based, and polyesterimide-based polymers and the like are listed.

Moreover, as the liquid crystal polymers of the side-chain type, the following can be listed: those having a main chain of polyacrylate, polymethacrylate, polysiloxane, polymalonate and the like, and having side chains of low molecular liquid crystalline compounds (mesogen parts), which comprise para-substituted cyclocompounds and the like, if necessary, via spacer parts, which comprise atomic groups with conjugate properties.

b. Liquid Crystal Regularity

In the present invention, the liquid crystal layer is formed by curing the above-described polymerizable liquid crystalline monomers, polymerizable liquid crystalline oligomers, polymerizable liquid crystalline polymers and liquid crystalline polymers, with predetermined liquid crystal regularity.

Here, if the optical element is the optical compensating element, the above-described liquid crystal layer has Nematic regularity or Smectic regularity.

The regularity is basically determined by liquid crystal regularity shown by the liquid crystal materials themselves to use. The liquid crystal regularity is obtained by coating the above-described liquid crystal materials onto the alignment layer and by aligning them in accordance with the shape transferred to the transparent base material. Then, the liquid crystal materials are cured with the liquid crystal regularity, to thereby form the liquid crystal layer.

c. Others

The thickness of the liquid crystal layer used in the present invention is preferably in a range of 0.2 to 10 μm, and particularly 0.4 to 6 μm. This is because when the optical element of the present invention is used as the optical compensating element, in some cases, optical anisotropy arises needlessly if the liquid crystal layer is thicker than the above-described range, and predetermined optical anisotropy cannot be achieved if the liquid crystal layer is thinner than the above-described range. Thus, the thickness of the liquid crystal layer may be determined in accordance with the required optical anisotropy.

In the present invention, the alignment angle of liquid crystals in the above-described liquid crystal layer can be set to an arbitrary angle with respect to the longitudinal direction of the transparent base material. For example, if the liquid crystals are aligned in the cross direction with respect to the longitudinal direction of the transparent base material, the alignment angle of the liquid crystals is preferably in a range of 90°±2°, and more preferably 90°±0.5°. Moreover, if the liquid crystals are aligned in a 45° direction with respect to the longitudinal direction of the transparent base material, the alignment angle of the liquid crystals is preferably in a range of 45°±2°, and more preferably 45°±0.5°. Incidentally, the used alignment angle is a value measured by using a phase difference or retardation measurement device (manufactured by Oji Scientific Instruments, Product name KOBRA).

In the present invention, it is preferable that liquid crystals are aligned in the direction crossing the longitudinal direction of the long transparent base material. This is because, for example, if the optical element of the present invention is used as the optical compensating element in order to improve the dependency on an angle of visibility of the LCD, the optical compensating element can be pasted with the polarizing plate whose absorbing axis faces in the longitudinal direction of the long transparent base material, cut into a predetermined size, and incorporated into the LCD. It is also because it is possible to provide the optical compensating element having such desired optical properties, easily and inexpensively.

Incidentally, the method for forming the liquid crystal layer of the present invention will be described in “D. Method for manufacturing Optical Element” as described later, so that its explanation is omitted here.

2. Application

Next, the application of the optical element of the present invention will be explained.

The optical element of the present invention is mainly used for the optical compensating element. For example, if the optical compensating element using liquid crystals is incorporated in order to improve the angle of visibility of the LCD, it is necessary to paste the polarizing plate and the optical compensating element such that the absorbing axis of the polarizing plate and the optical axis of the optical compensating element make a particular angle, such as 90°. The reason is as follows. The polarizing plate is typically prepared by drawing a polymer film in the longitudinal direction, so that the absorbing axis thereof faces in the longitudinal direction of the film base material. As described above, in the present invention, the liquid crystals can be aligned in the direction crossing the longitudinal direction of the long transparent base material, so that it is possible to paste the optical compensating element with the polarization plate whose absorbing axis faces in the longitudinal direction of the transparent base material as described above, cut them into a predetermined size, and incorporate them into the LCD.

Moreover, the optical element of the present invention can be used for security members. For example, the optical element of the present invention may be used to prevent the forgery and copy of prepaid cards, ID cards, computer software, music software, and the like. In this case, the optical element is attached to and used for one portion of the prepaid cards and music software and the like. In the optical element, only linear polarization in a particular direction can be recognized by observing through the polarizing plate or with the irradiation of polarized light. Thus, in observation under natural light, a part to which the optical element is attached cannot be recognized, so that the optical element can be used as the security members to prevent the forgery and copy.

C. Method for manufacturing Alignment-Layer-Attached Film for Optical Element Use

Next, the method for manufacturing the alignment-layer-attached film for optical element use of the present invention will be explained.

In the method for manufacturing the alignment-layer-attached film for optical element use of the present invention, there are two embodiments, depending on a coating process of coating the curing resin composition, as described later. Each embodiment will be explained below, separately.

### 1. First Embodiment

The first embodiment of a method for manufacturing an alignment-layer-attached film for optical element use of the present invention, is a method for manufacturing an alignment-layer-attached film for optical element use, which comprises: a long transparent base material which can be continuously displaced; and an alignment layer formed on the transparent base material, the method for manufacturing comprising: a coating process of coating a curing resin composition onto a transferring member having a concavo-convex shape to align liquid crystals; a curing process of curing the curing resin composition to be a curing resin; a placing process of placing the transparent base material onto a surface of the curing resin composition or the curing resin; and a transferring process of delaminating the transferring member from the curing resin composition or the curing resin and transferring the concavo-convex shape of the transferring member to the curing resin.

By forming the concavo-convex shape of the transferring member to align liquid crystals in the direction crossing the longitudinal direction of the long transparent base material, it is possible to provide the alignment-layer-attached film for optical element use in which the liquid crystals can be aligned in the direction crossing the longitudinal direction of the longitudinal direction of the transparent base material by using the transferred concavo-convex shape. Moreover, there is also such an advantage that the productivity improves since it is possible to mass-produce the alignment-layer-attached film for optical element use in which the liquid crystals can be aligned in the direction crossing the longitudinal direction of the transparent base material, by producing once an original plate of the transferring member.

The first embodiment will be explained with reference to the drawings. FIG. 2A to FIG. 2E show one example of the method for manufacturing the alignment-layer-attached film for optical element use of the present embodiment. At first, as shown in FIG. 2A, a coating process of coating a curing resin composition 3 onto the transferring member 4 having the concavo-convex shape to align liquid crystals is performed. Then, as shown in FIG. 2B, a curing process of curing the curing resin composition 3 by irradiation of energy 6 to be a curing resin 5 is performed. Moreover, the long transparent base material 1 is placed onto the surface of the curing resin 5 (FIG. 2C, placing process), and a transferring process of delaminating or exfoliating the transferring member 4 from the curing resin 5 (FIG. 2D) and transferring the concavo-convex shape of the transferring member 4 to the curing resin 5 (FIG. 2E) is performed.

The method for manufacturing the alignment-layer-attached film for optical element use of the present invention as shown in the above-described example will be explained, hereinafter, for each process.

a. Coating Process

In manufacturing the alignment-layer-attached film for optical element use of the present embodiment, the coating process of coating the curing resin composition onto the transferring member having the concavo-convex shape to align liquid crystals is performed.

As the coating method of coating the curing resin composition, spin coating, roll coating, printing, dipping & pulling-up, curtain coating (dye-coating), and the like are listed.

The thickness of the coated curing resin composition is preferably in a range of 1 to 30 μm, and particularly preferably 1 to 15 μm. This is because if the thickness is thinner than the above-described range, there is a possibility that the concavo-convex shape of the transferring member is not sufficiently transferred when the curing resin composition is cured and the concavo-convex shape of the transferring member is transferred to the curing resin. It is also because if the thickness is thicker than the above-described range, the LCD possibly becomes thicker in the case where the alignment-layer-attached film for optical element use of the present invention is used for the optical compensating element of the LCD, for example. Moreover, it is also because if the transparent base material is a film, such a disadvantage possibly arises that the coating surface is easily curled.

In order for the curing resin composition to have a desired thickness, it is possible to coat it in the above-described methods while controlling a coating amount. Alternatively, it is also possible to remove the excess curing resin composition after the coating. As the method of removing the excess curing resin composition, removing it by using a roller, scraping it off by using a doctor, and the like are listed. Moreover, a process of removing the excess curing resin composition may be performed after coating the curing resin composition, or after placing the transparent base material onto the surface of the curing resin composition, as described later.

Incidentally, the curing resin composition and the transferring member used in the present invention are the same as those described in the section of the alignment layer in “A. Alignment-Layer-Attached Film for Optical Element Use”, so that their explanations are omitted here.

b. Curing Process

In the present embodiment, the curing process of curing the curing resin composition to be the curing resin is performed.

As the method of curing the curing resin composition, irradiating with energy rays, heating, and the like are listed, however, in the present embodiment, the method of irradiation of energy rays is preferable. The energy rays in the present embodiment indicate those capable of inducing polymerization with respect to monomers and polymers contained in the curing resin composition. As explained in the above-described “A. Alignment-Layer-Attached Film for Optical Element Use”, the polymerization initiator may be contained in the curing resin composition if necessary.

The energy rays are not particularly limited if capable of polymerizing the curing resin composition; however, from the viewpoint of usability of an apparatus or the like, UV radiation or visible light is typically used. The applied light is preferably used at wavelengths of 150 to 500 nm, preferably 250 to 450 nm, and more preferably 300 to 400 nm.

In the present embodiment, a preferable method may be irradiation of UV rays as the energy rays. This is because the method of using UV rays as active radiation is an already established technique, so that its application to the present invention is easy, including the photopolymerization initiator to use.

As the light source of the applied light, a low pressure mercury lamp (bactericidal lamp, fluorescent chemical lamp, and black light), a high pressure discharge lamp (high pressure mercury lamp and metal halide lamp), a short arc discharge lamp (super high pressure mercury lamp, xenon lamp, and mercury xenon lamp) and the like can be exemplified. Among them, the use of the metal halide lamp, the xenon lamp, the high pressure mercury lamp, and the like is recommended.

The irradiation intensity is adjusted, as occasion demands, depending on the composition of the curing resin composition and the amount of the photopolymerization initiator.

The thickness of the curing resin prepared by curing the curing resin composition is preferably in a range of 0.5 to 30 μm, and particularly preferably 1 to 15 μm. This is because if the thickness is thicker than the above-described range, the LCD possibly becomes thicker and heavier, in the case where the alignment-layer-attached film for optical element use of the present invention is used for the optical compensating element of the LCD, for example. Moreover, it is also because if the thickness is thinner than the above-described range, the strength is inferior.

In the present embodiment, the curing process may be performed after any of the coating, placing, and transferring processes. Namely, the curing process may be performed in any of the following cases: curing after the curing resin composition is coated onto the transferring member (after the coating process) ; curing after the transparent base material is placed onto the surface of the curing resin composition (after the placing process); and curing after the transferring member is delaminated from the curing resin composition (after the transferring process). The curing process will be explained in the following three aspects.

(i) First Aspect

In the present embodiment, the first aspect of the curing process is as follows, as shown in FIG. 2A to FIG. 2E. The curing resin composition 3 is coated onto the transferring member 4 having the concavo-convex shape to align liquid crystals (FIG. 2A). It is irradiated with the energy 6 to cure the curing resin composition 3 (FIG. 2B). The transparent base material 1 is placed onto the surface of the curing resin 5 which is prepared by the curing (FIG. 2C). The transferring member 4 is delaminated from the curing resin 5 (FIG. 2D) . The concavo-convex shape of the transferring member 4 is transferred to the curing resin 5 (FIG. 2E).

At this time, as the irradiation direction of energy rays to cure the curing resin composition, it may be from the transferring member side, or from the curing resin composition side. However, in the case of the irradiation from the transferring member side, the transferring member is required to be made of a transparent material.

Moreover, after the curing resin composition is cured, the transferring member is placed onto the surface of the curing resin prepared by the curing, and then, the concavo-convex shape of the transferring member is transferred, so that the curing resin needs to have a predetermined viscosity even after the curing. Thus, it is preferable not to completely cure the curing resin composition, and it may be cured again after the transparent base material is placed onto the surface of the curing resin, or after the transferring member is delaminated from the curing resin.

(ii) Second Aspect

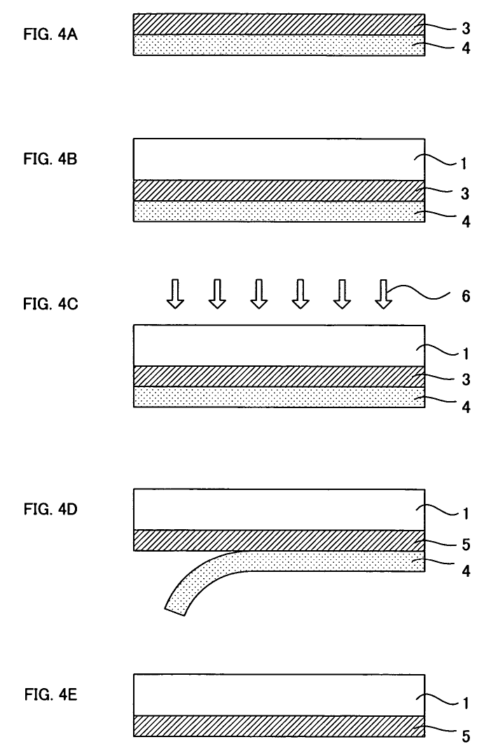

In the present embodiment, the second aspect of the curing process is as follows, as shown in FIG. 4A to FIG. 4E. The curing resin composition 3 is coated onto the transferring member 4 having the concavo-convex shape to align liquid crystals (FIG. 4A). The transparent base material 1 is placed onto the surface of the curing resin composition 3 (FIG. 4B). It is irradiated with the energy 6 to cure the curing resin composition 3 (FIG. 4C). The transferring member 4 is delaminated from the curing resin 5 which is prepared by the curing (FIG. 4D). The concavo-convex shape of the transferring member 4 is transferred to the curing resin 5 (FIG. 4E).

At this time, as the irradiation direction of energy rays to cure the curing resin composition, it may be from the transferring member side, or from the transparent base material side. However, in the case of the irradiation from the transferring member side, the transferring member is required to be made of a transparent material.

(iii) Third Aspect

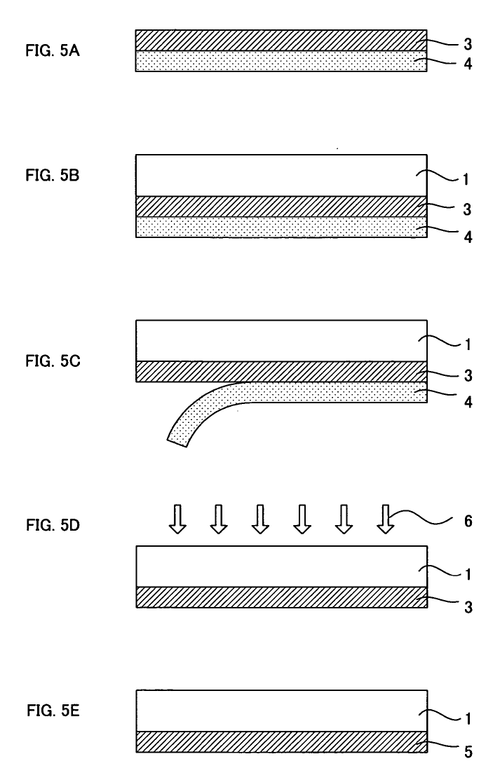

In the present embodiment, the third aspect of the curing process is as follows, as shown in FIG. 5A to FIG. 5E. The curing resin composition 3 is coated onto the transferring member 4 having the concavo-convex shape to align liquid crystals (FIG. 5A). The transparent base material 1 is placed onto the surface of the curing resin composition 3 (FIG. 5B) . The transferring member 4 is delaminated from the curing resin composition 3 (FIG. 5C) . It is irradiated with the energy 6 to cure the curing resin composition 3 (FIG. 5D). The concavo-convex shape of the transferring member 4 is transferred to the curing resin 5 (FIG. 5E).

At this time, as the irradiation direction of energy rays to cure the curing resin composition, it may be from the curing resin composition side, or from the transparent base material side.

Moreover, after the transferring member is delaminated from the curing resin composition, the curing resin composition to which the concavo-convex shape of the transferring member is transferred is cured, so that the curing resin composition needs to maintain the concavo-convex shape of the transferring member even after the transferring member is delaminated. Thus, in order for the curing resin composition to have a predetermined viscosity, the curing resin composition may be set in a semi-curing state before the transferring member is delaminated therefrom.

c. Placing Process

In the present embodiment, the placing process of placing the transparent base material onto the surface of the curing resin composition or the curing resin is performed.

The method of placing the transparent base material onto the surface of the curing resin composition or the curing resin is not particularly limited if the transparent base material is placed in contact with the curing resin composition or the curing resin; however, it is preferable to place the transparent base material in close adhesion to the curing resin composition or the curing resin. This is because the curing resin composition or the curing resin is displaced from the transferring member to the transparent base material, so that it is required to closely adhere to the transparent base material.

Therefore, in order to improve the close adhesion between the transparent base material and the curing resin composition or the curing resin, a surface treatment is preferably performed onto the transparent base material. Specifically, a glow discharge treatment, a corona discharge treatment, a UV treatment, a saponification treatment, and the like can be used. Moreover, a primer layer may be formed on the transparent base material. Furthermore, the primer layer (barrier layer) may be provided for the purpose of protection of the transparent base material from the curing resin. As the primer layer, for example, silane-based and titanium-based coupling agents and the like are listed.

Incidentally, the long transparent base material used in the present invention is the same as that described in the above-described “A. Alignment-Layer-Attached Film for Optical Element Use”, so that its explanation is omitted here.

d. Transferring Process

In the present embodiment, the transferring process of delaminating the transferring member from the curing resin composition or the curing resin and transferring the concavo-convex shape of the transferring member to the curing resin is performed.

The method of delaminating the transferring member from the curing resin composition or the curing resin is not particularly limited, if the curing resin composition or the curing resin is displaced from the transferring member to the transparent base material and the concavo-convex shape of the transferring member is transferred to the curing resin composition or the curing resin.

In the present embodiment, the transferring member is displaced by a cylindrical drum for transfer, and the long transparent base material is displaced by a cylindrical drum for the base material, and it is preferable to form the alignment layer by coating the curing resin composition onto the transferring member, by contacting the curing resin composition or the curing resin with the transparent base material on the two cylindrical drums, by delaminating or peel off the transferring member from the curing resin composition or the curing resin, and by continuously transferring the concavo-convex shape of the transferring member to the curing resin. Moreover, the transferring member is preferably the cylindrical drum for transfer. This is because the transfer of the shape can be continuously performed on the transparent base material through the roll-to-roll process, so that the productivity improves.

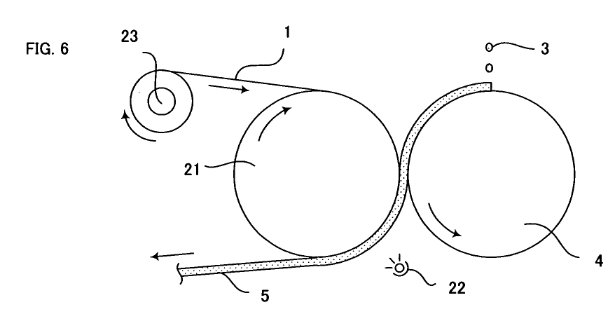

The roll-to-roll process will be explained with reference to a drawing. FIG. 6 shows an example of the method for forming the alignment layer in the present embodiment. As shown in FIG. 6, the transferring member 4 is a cylindrical drum for transfer. The long transparent base material 1 is supplied from a supply roll 23, passes through a cylindrical drum 21 for the base material, and is rolled up by a not-illustrated winding roll. The alignment layer is formed by coating the curing resin composition 3 onto the transferring member 4, by contacting the curing resin composition 3 with the transparent base material 1 on the two cylindrical drums 21 and 4, by delaminating or peel off the transferring member 4 from the curing resin composition 3, by irradiating it with energy from a light source 22 to thereby cure the curing resin composition 3 to be the curing resin 5, and by continuously transferring the concavo-convex shape of the transferring member 4 to the curing resin 5.

### 2. Second Embodiment

Next, the second embodiment of the method for manufacturing an alignment-layer-attached film for optical element use of the present invention will be explained.

The second embodiment of the method for manufacturing an alignment-layer-attached film for optical element use of the present invention is a method for manufacturing an alignment-layer-attached film for optical element use, which comprises: a long transparent base material which can be continuously displaced; and an alignment layer formed on the transparent base material, the method for manufacturing comprising: a coating process of coating a curing resin composition onto the transparent base material; a curing process of curing the curing resin composition to be a curing resin; a placing process of placing a transferring member having a concavo-convex shape to align liquid crystals, onto a surface of the curing resin composition or the curing resin; and a transferring process of delaminating the transferring member from the curing resin composition or the curing resin on the transparent base material and transferring the concavo-convex shape of the transferring member to the curing resin.

In the present invention, by forming the concavo-convex shape of the transferring member such that liquid crystals are aligned in the direction crossing the longitudinal direction of the long transparent base material, it is possible to provide the alignment-layer-attached film for optical element use in which the liquid crystals can be aligned in the direction crossing the longitudinal direction of the transparent base material by using the transferred concavo-convex shape. Moreover, there is also such an advantage that the productivity improves since it is possible to mass-produce the alignment-layer-attached film for optical element use in which the liquid crystals can be aligned in the direction crossing the longitudinal direction of the transparent base material, by producing once an original plate of the transferring member.

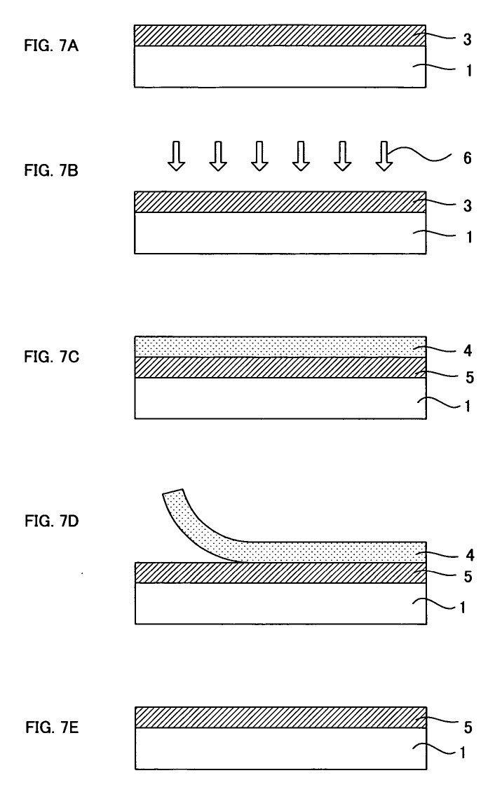

The present embodiment will be explained with reference to the drawings. FIG. 7A to FIG. 7E show an example of the method for manufacturing the alignment-layer-attached film for optical element use of the present invention. At first, as shown in FIG. 7A, a coating process of coating the curing resin composition 3 onto the transparent base material 1 is performed. Then, as shown in FIG. 7B, a curing process of curing the curing resin composition 3 by irradiating it with the energy 6 to be the curing resin 5 is performed. Moreover, the transferring member 4 having the concavo-convex shape to align liquid crystals is placed onto the surface of the curing resin 5 (FIG. 7C, placing process) , and a transferring process of delaminating the transferring member 4 from the curing resin 5 (FIG. 7D) and transferring the concavo-convex shape of the transferring member 4 to the curing resin 5 (FIG. 7E) is performed.

The method for manufacturing the alignment-layer-attached film for optical element use of the present invention as shown in the above-described example will be explained, hereinafter, for each process.

a. Coating Process

In manufacturing the alignment-layer-attached film for optical element use of the present embodiment, the coating process of coating the curing resin composition onto the long transparent base material is performed.

Incidentally, the transparent base material and the curing resin composition used in the present invention are the same as those described in “A. Alignment-Layer-Attached Film for Optical Element Use”, and the method for coating the curing resin composition is the same as that described in the first embodiment, so that their explanations are omitted here.

b. Curing Process

In the present embodiment, the curing process of curing the curing resin composition to be the curing resin is performed.

In the present embodiment, the curing process may be performed after any of the coating, placing, and transferring processes. Namely, the curing process may be performed in any of the following cases: curing after the curing resin composition is coated onto the transparent base material (after the coating process); curing after the transferring member is placed onto the surface of the curing resin composition (after the placing process); and curing after the transferring member is delaminated from the curing resin composition (after the transferring process). The curing process will be explained in the following three aspects.

(i) First Aspect

In the present embodiment, the first aspect of the curing process of curing the curing resin composition is as follows, as shown in FIG. 7A to FIG. 7E. The curing resin composition 3 is coated onto the transparent base material 1 (FIG. 7A) . It is irradiated with the energy 6 to cure the curing resin composition 3 (FIG. 7B) . The transferring member 4 is placed onto the surface of the curing resin 5 which is prepared by the curing (FIG. 7C). The transferring member 4 is delaminated from the curing resin 5 (FIG. 7D) . The concavo-convex shape of the transferring member 4 is transferred to the curing resin 5 (FIG. 7E).

At this time, as the irradiation direction of energy rays to cure the curing resin composition, it may be from the transparent base material side, or from the curing resin composition side.

Moreover, after the curing resin composition is cured, the transferring member is placed onto the surface of the curing resin prepared by the curing, and then, the concavo-convex shape of the transferring member is transferred, so that the curing resin needs to have a predetermined viscosity even after the curing. Thus, it is preferable not to completely cure the curing resin composition, and it may be cured again after the transferring member is placed onto the surface of the curing resin, or after the transferring member is delaminated from the curing resin.

(ii) Second Aspect

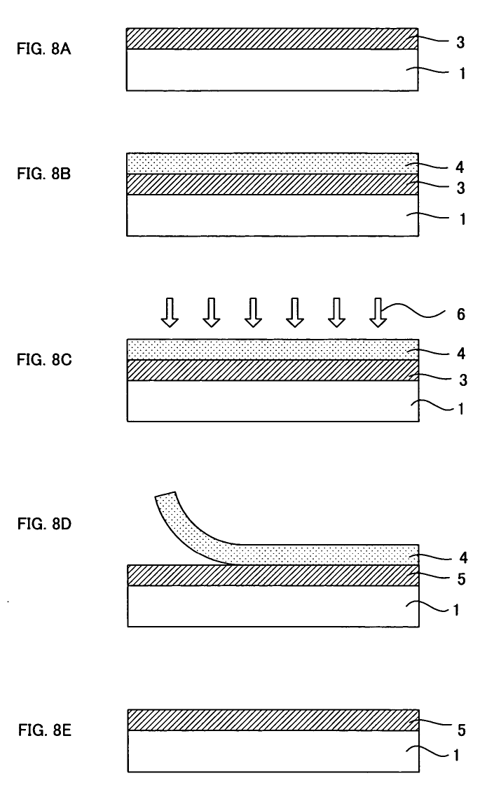

In the present embodiment, the second aspect of the curing process of curing the curing resin composition is as follows, as shown in FIG. 8A to FIG. 8E. The curing resin composition 3 is coated onto the transparent base material 1 (FIG. 8A) . The transferring member 4 is placed onto the surface of the curing resin composition 3 (FIG. 8B). It is irradiated with the energy 6 to cure the curing resin composition 3 (FIG. 8C). The transferring member 4 is delaminated from the curing resin 5 which is prepared by the curing (FIG. 8D) . The concavo-convex shape of the transferring member 4 is transferred to the curing resin 5 (FIG. 8E).

At this time, as the irradiation direction of energy rays to cure the curing resin composition, it may be from the transferring member side, or from the transparent base material side. However, in the case of the irradiation from the transferring member side, the transferring member is required to be made of a transparent material.

(iii) Third Aspect

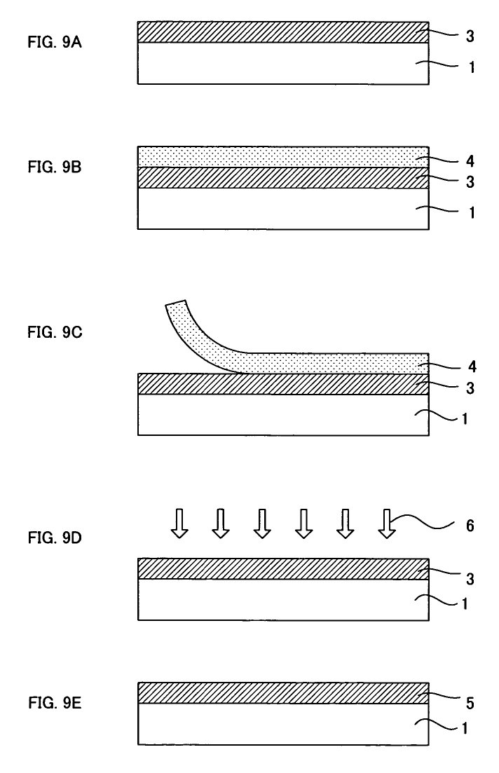

In the present embodiment, the third aspect of the curing process of curing the curing resin composition is as follows, as shown in FIG. 9A to FIG. 9E. The curing resin composition 3 is coated onto the transparent base material 1 (FIG. 9A) . The transferring member 4 is placed onto the surface of the curing resin composition 3 (FIG. 9B). The transferring member 4 is delaminated from the curing resin composition 3 (FIG. 9C). It is irradiated with the energy 6 to cure the curing resin composition 3 (FIG. 9D). The concavo-convex shape of the transferring member 4 is transferred to the curing resin 5 (FIG. 9E).

At this time, as the irradiation direction of energy rays to cure the curing resin composition, it may be from the curing resin composition side, or from the transparent base material side.

Moreover, after the transferring member is delaminated from the curing resin composition, the curing resin composition to which the concavo-convex shape of the transferring member is transferred is cured, so that the curing resin composition needs to maintain the concavo-convex shape of the transferring member even after the transferring member is delaminated. Thus, in order for the curing resin composition to have a predetermined viscosity, the curing resin composition may be set in a semi-curing state before the transferring member is delaminated therefrom.

Incidentally, the method for curing the curing resin composition, the energy used in the curing, and the like are the same as those described in the first embodiment, so that their explanations are omitted here.

c. Placing Process

In the present embodiment, the placing process of placing the transferring member onto the surface of the curing resin composition or the curing resin on the transparent base material is performed.

The method of placing the transferring member onto the surface of the curing resin composition or the curing resin is not particularly limited if the transferring member is placed in contact with the curing resin composition or the curing resin; however, it is preferable to place the transferring member in close adhesion to the curing resin composition or the curing resin. This is because the concavo-convex shape of the transferring member is transferred to the surface of the curing resin composition or the curing resin, so that it is required to closely adhere to the transferring member.

Incidentally, the transferring member used in the present invention is the same as that described in the above-described “A. Alignment-Layer-Attached Film for Optical Element Use”, so that its explanation is omitted here.

d. Transferring Process

In the present embodiment, the transferring process of delaminating the transferring member from the curing resin composition or the curing resin, and transferring the concavo-convex shape of the transferring member to the curing resin is performed.

The method of delaminating the transferring member from the curing resin composition or the curing resin on the transparent base material is not particularly limited, if the curing resin composition or the curing resin is not delaminated from the transparent base material and the concavo-convex shape of the transferring member is transferred to the curing resin composition or the curing resin.

Therefore, in order to improve the close adhesion between the transparent base material and the curing resin composition or the curing resin, a surface treatment is preferably performed onto the transparent base material. Specifically, a glow discharge treatment, a corona discharge treatment, a UV treatment, a saponification treatment, and the like can be used. Moreover, a primer layer may be formed on the transparent base material. Furthermore, the primer layer (barrier layer) may be provided for the purpose of protection of the transparent base material from the curing resin. As the primer layer, for example, silane-based and titanium-based coupling agents and the like are listed.

In the present embodiment, the transferring member is displaced by a cylindrical drum for transfer, and the long transparent base material is displaced by a cylindrical drum for the base material, and it is preferable to form the alignment layer by coating the curing resin composition onto the transparent base material, by contacting the curing resin composition or the curing resin with the transferring member on the two cylindrical drums, by delaminating or peel off the transferring member from the curing resin composition or the curing resin on the transparent base material, and by continuously transferring the concavo-convex shape of the transferring member to the curing resin. Moreover, the transferring member is preferably the cylindrical drum for transfer. This is because the transfer of the shape can be continuously performed on the transparent base material through the roll-to-roll process, so that the productivity improves.

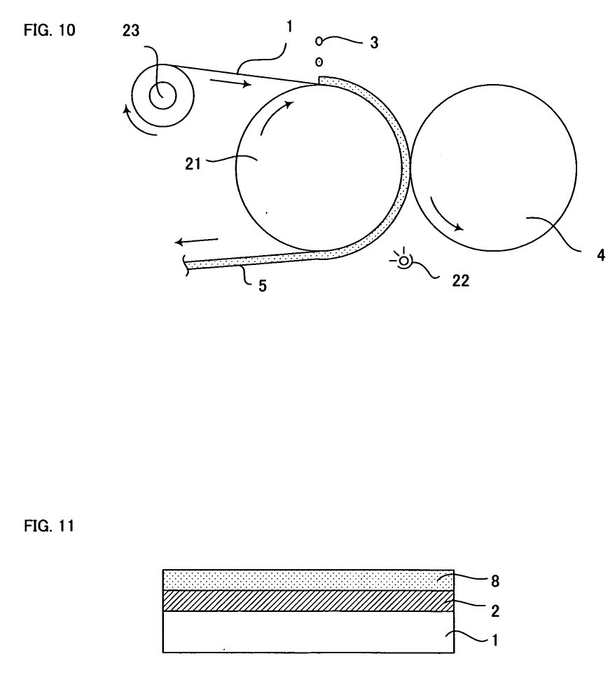

The roll-to-roll process will be explained with reference to a drawing. FIG. 10 shows an example of the method for forming the alignment layer in the present embodiment. As shown in FIG. 10, the transferring member 4 is a cylindrical drum for transfer. The long transparent base material 1 is supplied from the supply roll 23, passes through the cylindrical drum 21 for the base material, and is rolled up by a not-illustrated winding roll. The alignment layer is formed by coating the curing resin composition 3 onto the transparent base material 1, by contacting the curing resin composition 3 with the transferring member 4 on the two cylindrical drums 21 and 4, by delaminating or peel off the transferring member 4 from the curing resin composition 3 on the transparent base material 1, by irradiating it with energy from the light source 22 to thereby cure the curing resin composition 3 to be the curing resin 5, and by continuously transferring the concavo-convex shape of the transferring member 4 to the curing resin 5.

D. Method for manufacturing Optical Element

Next, the method for manufacturing an optical element of the present invention will be explained.

The method for manufacturing an optical element in the present invention is a method for manufacturing an optical element, comprising: . an alignment-layer-attached film for optical element use forming process of forming an alignment-layer-attached film for optical element use by the method for manufacturing an alignment-layer-attached film for optical element use according to the above mentioned invention; and a liquid-crystal-layer-forming process of coating liquid crystals onto an alignment layer of the alignment-layer-attached film for optical element use, performing an alignment treatment, and fixing alignment of the liquid crystals.

In the method for manufacturing the optical element by using the above-described method for manufacturing an alignment-layer-attached film for optical element use, it is possible to provide the optical element in which liquid crystals can be aligned in the direction crossing the longitudinal direction of the transparent base material. Moreover, there is also such an advantage that the productivity improves since it is possible to mass-produce the optical element in which the liquid crystals are aligned in the direction crossing the longitudinal direction of the transparent base material, by producing once an original plate of the transferring member.

Incidentally, the method for manufacturing the alignment-layer-attached film for optical element use, which is used in the present invention, is the same as that described in “C. Method for manufacturing Alignment-Layer-Attached Film for Optical Element Use”, so that its explanation is omitted here.

The liquid-crystal-layer-forming process in the method for manufacturing the optical element of the present invention will be explained below.

1. Liquid-crystal-layer-forming Process

In the method for manufacturing the optical element of the present invention, the liquid-crystal-layer-forming process of coating liquid crystals onto an alignment layer of the alignment-layer-attached film for optical element use, performing an alignment treatment, and fixing alignment of the liquid crystals is performed.

In the present invention, as shown in FIG. 11, the liquid crystal layer 8 is formed on the alignment layer 2. The liquid crystal layer of the present invention is formed by the liquid crystal materials described in “B. Optical Element”, and has the liquid crystal regularity.

In the method for forming the liquid crystal layer, a liquid-crystal-layer-forming composition including the liquid crystal materials is coated onto the alignment layer, to thereby form a liquid-crystal-layer-forming layer. The liquid crystal materials are aligned in accordance with the transferred concavo-convex shape, and cured in a condition having the liquid crystal regularity, to thereby form the liquid crystal layer in which the alignment of liquid crystals is fixed. Each process of the method for forming the liquid crystal layer will be explained below.

a. Liquid-crystal-layer-forming Layer Forming Process

In the present invention, as the method for forming the liquid-crystal-layer-forming layer, the following methods can be adopted: for example, a method in which a dry film or the like is formed in advance as the liquid-crystal-layer-forming layer and this layer is laminated onto the alignment layer; a method in which the liquid-crystal-layer-forming composition is melted to coat the composition onto the alignment layer; and the like. In the present invention, however, it is preferable to form the liquid-crystal-layer-forming layer, by dissolving the liquid-crystal-layer-forming composition in a solvent to prepare a liquid-crystal-layer-forming coating solution, by coating the coating solution onto the alignment layer, and by removing the solvent. This is because this method is simpler in processes than the other methods.

As the coating method of coating the liquid-crystal-layer-forming composition, spin coating, roll coating, printing, dipping & pulling-up, curtain coating (dye-coating), casting, bar coating, blade coating, spray coating, gravure coating, reverse coating, extrusion coating, and the like are listed.

After the liquid-crystal-layer-forming coating solution is coated in the above manner, the solvent is removed. As the method for removing the solvent, for example, removal under a reduced pressure, removal by heating, or a combination thereof, and the like are used. By removing the solvent, the liquid-crystal-layer-forming layer is formed.

In the present invention, the condition of the liquid crystal materials in the liquid-crystal-layer-forming layer formed in this manner is changed to a condition having the liquid crystal regularly, by the shape transferred to the surface of the alignment layer. This is typically performed by a method of heating at a N-I transition point or less, or similar methods. Incidentally, the N-I transition point indicates a transition temperature from the liquid crystal phase to the isotropic phase.

The liquid crystal materials and the photopolymerization initiator used for the liquid-crystal-layer-forming coating solution are the same as those in the section of the liquid crystal layer of the above-described “B. Optical Element”, so that their explanations are omitted here. The solvent used for the liquid-crystal-layer-forming coating solution and other additives will be explained below.

(Solvent)

The solvent used for the liquid-crystal-layer-forming coating solution is not particularly limited, if capable of dissolving the liquid crystal materials and not interfering with the alignment property of the alignment layer.

Specifically, the following can be exempliefied: benzene, toluene, xylene, n-butylbenzene, diethylbenzene, tetralin, and the like in hydrocarbons; methoxybenzene, 1,2-dimethoxybenzen, diethyleneglycol dimethylether and the like in ethers; acetone, methyletheylketone, methylisobutylketone, cyclohexanone, 2,4-pentanedione and the like in ketones; ethyl acetate, ethylene glycol monomethylether acetate, propylene glycol monomethylether acetate, propylene glycol monoethylether acetate, y-butyrolactone and the like in esters; 2-pyrrolidone, N-mehtyl-2-pyrrolidone, dimethylformamide, dimethylacetoamide and the like in amide-based solvents; chloroform, dichloromethane, carbon tetrachloride, dichloroethane, tetrachloroethan, trichloroethylene, tetrachloroethylene, chlorobenzene, ortho-dichlorobenzene, and the like in halogen-based solvents; t-butyl alcohol, diacetone alcohol, glycerin, monoacetin, ethylene glycol, triethylene glycol, hexylene glycol, ethylene glycol monomethylether, ethyl cellosolve, butyl cellosolve, and the like in alcohols; phenol, para-chlorophenol and the like in phenols. Moreover, one or more types of solvents can be used.

If a single type of the solvent is used, in some cases, the solubility of the liquid crystal materials and the like may be insufficient, or the alignment layer having the alignment property, as described above, may be dissolved. However, by mixing and using two or more types of the solvents, it is possible to avoid the disadvantage. Among the above-described solvents, hydrocarbon-based solvents and glycol monoether acetate-based solvents are preferable as the single solvents. As the mixed solvent, the combination between ethers or ketones and glycols is preferable. The concentration of the solution cannot be generalized because it depends on the solubility of the liquid crystalline composition and the thickness of the liquid crystal layer whose production is desired; however, it is adjusted typically in a range of 1 to 60 weight %, and preferably 3 to 40 weight %.

(Other Additives)

Into the liquid-crystal-layer-forming coating solution used in the present invention, additives other than the above-described compounds can be added, to an extent not hindering the purpose of the present invention. As the additives, for example, polyester (meth)acrylate, which is prepared by reacting (meta)acrylic acid with polyester prepolymer prepared by the condensation of polyhydric alcohol and monobasic or polybasic acid; polyurethane (meth)acrylate, which is prepared by reacing (meth) acrylic acid with the reaction product of a reaction between a compound having a polyol group and a compound having two isocyanate groups; photopolymerizable compounds, such as epoxy (meth)acrylate, which is prepared by reacting (meth)acrylic acid with epoxy resin, such as bisphenol A epoxy resin, bisphenol F epoxy resin, novolac epoxy resin, polycarbonic acid polyglycidyl ester, polyol polyglycidyl ether, aliphatic or alicyclic epoxy resin, amine epoxy resin, triphenol methan epoxy resin, and dihydroxybenzene epoxy resin; photopolymerizable liquid crystalline compounds having an acryl group or a methacryl group; and the like are listed. The dosage of the compounds with respect to the liquid crystalline composition of the present invention is selected in a range not hindering the purpose of the present invention, and typically, it is 40 weight% or less, and preferably 20 weight% or less of the liquid crystalline composition of the present invention. The addition of the compounds improves the curing properties of the liquid crystal materials of the present invention, increases the mechanical strength of the prepared liquid crystal layer, and improves its stability.

Moreover, into the above-described liquid-crystal-layer-forming coating solution, surfactants and the like can be added, in order to facilitate the coating. As examples of the surfactants which can be added, imidazoline, quaternary ammonium salt, alkylamineoxide, polyamine derivatives, and the like in cationic surfactants; polyoxyethylene-polyoxypropylene condensate, primary or secondary alcohol ethoxylate, alkylphenol ethoxylate, polyethylene glycol and its ester, sodium lauryl sulfate, ammonium lauryl sulfate, lauryl sulfate amines, alkyl-substituted aromatic sulfonate, alkyl phosophate, aliphatic or aromatic sulfonic acid formalin condensate and the like in anionic surfactants; lauryl amide propyl betaine, lauryl amino acetic acid betaine, and the like in amphoteric surfactants; polyethylene glycol fatty acid esters, polyoxyethylene alkylamine, and the like in nonionic surfactants; perfluoroalkyl sulfonate, perfluoroalkyl carbonate, perfluoroalkyl ethyleneoxide added type, perfluoroalkyl trimethylammonium salt, oligomers containing a perfluoroalkyl group• a hydrophilic group, oligomers containing a perfluoroalkyl group• a lipophilic group, urethane containing a perfluoroalkyl group, and the like in fluorinated surfactants; and the like are listed.

The dosage of the surfactants depends on the type of the surfactants, the type of the liquid crystal materials, the type of the solvents, and further the type of the alignment layer to which the solution is coated, however, it is typically in a range of 10 weight ppm to 10 weight %, with respect to the liquid crystalline composition contained in the solution, preferably 100 weight ppm to 5 weight %, and further preferably 0.1 to 1 weight %.

b. Alignment Fixing Process

In the present invention, the alignment fixing process of fixing the alignment of liquid crystals is performed with respect to the above-described liquid-crystal-layer-forming layer.

In the present invention, the alignment fixing process is performed in different methods, depending on the liquid crystal materials to use. Specifically, there are two cases; one is the case where the liquid crystal materials are polymerizable materials, and the other is the case where the liquid crystal materials are non-polymerizable polymer materials. The two cases, where the liquid crystal materials are polymerizable materials and where the liquid crystal materials are non-polymerizable polymer materials, will be explained below.

(Polymerizable Liquid Crystal Materials)

In the present invention, as described above, it is preferable to use polymerizable liquid crystalline materials such as the polymerizable liquid crystal materials, such as polymerizable liquid crystalline monomers, polymerizable liquid crystalline oligomers and polymerizable liquid crystalline polymers.

If the polymerizable liquid crystal materials are used, the alignment fixing process is a process of irradiating the liquid-crystal-layer-forming layer, made of the polymerizable liquid crystal materials, formed on the base material, and having the alignment property, with active radiation, which activates polymerization.

The active radiation in the present invention is radiation having polymerization ability with respect to the polymerizable materials, and if necessary, the polymerizable materials may contain the polymerization initiator.

The active radiation is not particularly limited if capable of polymerizing the polymerizable liquid crystal materials; however, from the viewpoint of usability of an apparatus or the like, UV radiation or visible light is typically used. The applied light is preferably used at wavelengths of 150 to 500 nm, preferably 250 to 45° nm, and more preferably 300 to 400 nm.

In the present invention, a preferable method may be to irradiate the polymerizable liquid crystal materials with UV rays as the active radiation, wherein the UV rays cause the polymerization initiator to generate radicals for the radical polymerization of the polymerizable liquid crystal materials. This is because the method of using UV rays as the active radiation is an already established technique, so that its application to the present invention is easy, including the polymerization initiator to be used.

As the light source of the applied light, a low pressure mercury lamp (bactericidal lamp, fluorescent chemical lamp, and black light), a high pressure discharge lamp (high pressure mercury lamp and metal halide lamp), a short arc discharge lamp (super high pressure mercury lamp, xenon lamp, and mercury xenon lamp) and the like can be exemplified. Among them, the use of the metal halide lamp, the xenon lamp, the high pressure mercury lamp, and the like is recommended.

The irradiation intensity is adjusted, as occasion demands, depending on the composition of the polymerizable liquid crystal materials, which forms the liquid crystal layer, and the amount of the photopolymerization initiator.

The alignment fixing process by the irradiation of the active irradiated rays, as described above, may be performed at a treatment temperature in the above-described the liquid-crystal-layer-forming layer forming process, i.e., in a temperature condition in which the polymerizable liquid crystal materials can form the liquid crystal phase. Alternatively, the alignment fixing process may be performed at a temperature lower than the temperature at which the liquid crystal phase is formed. This is because once the polymerizable liquid crystal materials form the liquid crystal phase, the alignment condition is not suddenly disordered even at a subsequently lowered temperature.

Incidentally, as the polymerizable materials, as described above, typical polymerizable materials, which do not have liquid crystalline properties, may be also used in some cases. Even in this case, the alignment fixing process can be performed in the same manner.

(Non-Polymerizable Polymer Materials)

If the non-polymerizable polymer materials are used, the alignment fixing process is a process of lowering the temperature at which the liquid crystal phase is formed to a temperature at which a solid phase is formed. In the liquid-crystal-layer-forming layer forming process, the liquid crystal polymers form the liquid crystal phase having Nematic or Smectic regularity in accordance with the transferred shape of the alignment layer. In this condition, by setting the temperature to a temperature at which a glass condition is formed, the liquid crystal layer can be formed.

Incidentally, the present invention is not limited to the above-described embodiments. The above-described embodiments are only examples, and any embodiments having substantially the same constitution and performing the same action and effect as the technological idea described in Claims of the present invention are included in the technological range of the present invention.

### EXAMPLES

The following examples will further illustrate the present invention.

### Example 1

(Preparation of Transferring Member)

A glass plate was used as a base member for a transferring member, and SiO₂ was used as a deposition source. An angle θ between the deposition direction and the vertical direction of the glass plate was set to 60°. A concavo-convex shape to align liquid crystals on the glass base member was formed by an oblique deposition method, to thereby prepare a transferring member.

(Preparation of Alignment-Layer-Attached Film for Optical Element Use)

A UV curing resin composition was coated onto the transferring member. A TAC film with a primer layer was contacted with the surface of the UV curing resin composition, and the excess UV curing resin composition was removed by a roller. Then, it was irradiated with 400 mJ/cm² of UV rays from the TAC film side to cure the UV curing resin composition, and the transferring member was delaminated. By a series of operations described above, an alignment-layer-attached film for optical element use was prepared.

(Preparation of Optical Element)

Onto the alignment-layer-attached film for optical element use, UV curing Nematic liquid crystals with toluene as a solvent (dilute concentration 36% ww) were coated. After dried at 80° C. for 1 minute, the Nematic liquid crystals were cured by UV irradiation, to thereby form a liquid crystal layer. By a series of operations described above, an optical element was prepared. An alignment angle of the liquid crystals in the liquid crystal layer of the prepared optical element was measured by the retardation measurement device (manufactured by Oji Scientific Instruments, Product name KOBRA). The alignment angle was 89.8°, and the liquid crystal molecules were aligned in the cross direction of the TAC film.

### Example 2

(Preparation of Transferring Member)

A cylindrical drum made of copper and a rubbing roll made of rayon were contacted so that they mutually cross at right angles, and then, rubbing was performed. Rubbing traces were formed along the cross direction of the copper cylindrical drum, to thereby prepare a transferring member.

(Preparation of Alignment-Layer-Attached Film for Optical Element Use)

After the surface of the transferring member was partially dipped into a UV curing resin composition, the excess UV curing resin composition on the surface of the transferring member was scraped off by using a doctor. Then, a TAC film was contacted with the surface of the UV curing resin composition. It was irradiated with UV rays to cure the UV curing resin composition, and the rubbing traces are transferred to a UV curing resin. By a series of operations described above, an alignment-layer-attached film for optical element use was prepared.

(Preparation of Optical Element)

Onto the alignment-layer-attached film for optical element use, UV curing Nematic liquid crystals with toluene as a solvent (dilute concentration 36% ww) were coated. After dried at 80° C. for 1 minute, the Nematic liquid crystals were cured by UV irradiation, to thereby form a liquid crystal layer. By a series of operations described above, an optical element was prepared. An alignment angle of the liquid crystals in the liquid crystal layer of the prepared optical element was measured by the retardation measurement device (manufactured by Oji Scientific Instruments, Product name KOBRA). The alignment angle was 89.80 , and the liquid crystal molecules were aligned in the cross direction of the TAC film.

### Example 3

(Preparation of Transferring Member)

A transferring member was prepared in the same manner as in the example 2.

(Preparation of Alignment-Layer-Attached Film for Optical Element Use)

After a primer layer is provided for a TAC film, a UV curing resin composition was coated thereon at a thickness of 8 μm. Then, the TAC film with the UV curing resin composition attached was continuously contacted with the surface of the transferring member. It was irradiated with UV rays to cure the UV curing resin composition, and the rubbing traces are transferred to a UV curing resin. By a series of operations described above, an alignment-layer-attached film for optical element use was prepared.

(Preparation of Optical Element)

An optical element was prepared in the same manner as in the example 2. An alignment angle of the liquid crystals in the liquid crystal layer of the prepared optical element was measured by the retardation measurement device (manufactured by Oji Scientific Instruments, Product name KOBRA) . The alignment angle was 89.8°, and the liquid crystal molecules were aligned in the cross direction of the TAC film.

### Example 4

(Preparation of Transferring Member)

A cylindrical drum made of copper and a rubbing roll made of rayon were contacted at an oblique angle of 45° with respect to a flow direction of the cylindrical drum. Rubbing was performed to form rubbing traces, to thereby prepare a transferring member.

(Preparation of Alignment-Layer-Attached Film for Optical Element Use)

An alignment-layer-attached film for optical element use was prepared in the same manner as in the example 2.

(Preparation of Optical Element)

An optical element was prepared in the same manner as in the example 2. An alignment angle of the liquid crystals in the liquid crystal. layer of the prepared optical element was measured by the retardation measurement device (manufactured by Oji Scientific Instruments, Product name KOBRA) . The alignment angle was 44.8°, and the liquid crystal molecules were aligned at approximately 45° with respect to the longitudinal direction of the TAC film.

1. An alignment-layer-attached film for optical element use, comprising:
a long transparent base material; and
an alignment layer formed on the transparent base material,
wherein the alignment layer comprising a resin having a concavo-convex shape to align liquid crystals.

2. The alignment-layer-attached film for optical element use according to claim 1, wherein an alignment direction of the liquid crystals aligned by the concavo-convex shape crosses a longitudinal direction of the transparent base material.

3. The alignment-layer-attached film for optical element use according to claim 1, wherein the alignment layer comprises a cured curing resin.

4. An optical element, comprising:
a long transparent base material;
an alignment layer formed on the transparent base material; and
a liquid crystal layer aligned and fixed by the alignment layer,
wherein the alignment layer comprising a resin having a concavo-convex shape to align liquid crystals.

5. The optical element according to claim 4, wherein an alignment direction of the liquid crystals aligned by the concavo-convex shape crosses a longitudinal direction of the transparent base material.

6. The optical element according to claim 4, wherein the alignment layer comprises a cured curing resin.

7. A method for manufacturing an alignment-layer-attached film for optical element use, which comprises: a long transparent base material which can be continuously displaced; and an alignment layer formed on the transparent base material,
the method for manufacturing comprising:
a coating process of coating a curing resin composition onto a transferring member having a concavo-convex shape to align liquid crystals;
a curing process of curing the curing resin composition to be a curing resin;
a placing process of placing the transparent base material onto a surface of the curing resin composition or the curing resin; and
a transferring process of delaminating the transferring member from the curing resin composition or the curing resin and transferring the concavo-convex shape of the transferring member to the curing resin.

8. The method for manufacturing an alignment-layer-attached film for optical element use according to claim 7, wherein the concavo-convex shape to align the liquid crystals is formed by oblique deposition.

9. The method for manufacturing an alignment-layer-attached film for optical element use according to claim 7, wherein the concavo-convex shape to align the liquid crystals is formed by rubbing.

10. The method for manufacturing an alignment-layer-attached film for optical element use according to claim 7, wherein
the transferring member is displaced by a cylindrical drum for transfer and the long transparent base material is displaced by a cylindrical drum for the base material, and
the coating process, the placing process in which the curing resin composition or the curing resin is contacted with the transparent base material on the two cylindrical drums, and the transferring process are continuously performed.

11. A method for manufacturing an alignment-layer-attached film for optical element use, which comprises: a long transparent base material which can be continuously displaced; and an alignment layer formed on the transparent base material,
the method for manufacturing comprising:
a coating process of coating a curing resin composition onto the transparent base material;
a curing process of curing the curing resin composition to be a curing resin;
a placing process of placing a transferring member having a concavo-convex shape to align liquid crystals, onto a surface of the curing resin composition or the curing resin; and
a transferring process of delaminating the transferring member from the curing resin composition or the curing resin on the transparent base material and transferring the concavo-convex shape of the transferring member to the curing resin.

12. The method for manufacturing an alignment-layer-attached film for optical element use according to claim 11, wherein the concavo-convex shape to align the liquid crystals is formed by oblique deposition.

13. The method for manufacturing an alignment-layer-attached film for optical element use according to claim 11, wherein the concavo-convex shape to align the liquid crystals is formed by rubbing.

14. The method for manufacturing an alignment-layer-attached film for optical element use according to claim 11, wherein
the transferring member is displaced by a cylindrical drum for transfer and the long transparent base material is displaced by a cylindrical drum for the base material, and
the coating process, the placing process in which the curing resin composition or the curing resin is contacted with the transferring member on the two cylindrical drums, and the transferring process are continuously performed.

15. A method for manufacturing an optical element, comprising:
an alignment-layer-attached film for optical element use forming process of forming an alignment-layer-attached film for optical element use by the method for manufacturing an alignment-layer-attached film for optical element use according to claim 7; and
a liquid-crystal-layer-forming process of coating liquid crystals onto an alignment layer of the alignment-layer-attached film for optical element use, performing an alignment treatment, and fixing alignment of the liquid crystals.

16. A method for manufacturing an optical element, comprising:
an alignment-layer-attached film for optical element use forming process of forming an alignment-layer-attached film for optical element use by the method for manufacturing a alignment-layer-attached film for optical element use according to claim 11; and
a liquid-crystal-layer-forming process of coating liquid crystals onto an alignment layer of the alignment-layer-attached film for optical element use, performing an alignment treatment, and fixing alignment of the liquid crystals.
